(19) United States
(12) Patent Application Publication
(10) Pub. No.: US 2024/0402662 A1
(43) Pub. Date: Dec. 5, 2024

(54) BUILDING MANAGEMENT SYSTEM WITH BUILDING EQUIPMENT SERVICING

(71) Applicant: Tyco Fire & Security GmbH, Neuhausen am Rheinfall (CH)

(72) Inventors: Rajiv Ramanasankaran, San Jose, CA (US); Sastry KM Malladi, Fremont, CA (US); Trent M. Swanson, Wellington, FL (US); Miguel Galvez, Westford, MA (US); Gregory A. Makowski, Los Altos, CA (US); Prashanthi Sudhakar, San Francisco, CA (US)

(21) Appl. No.: 18/677,664

(22) Filed: May 29, 2024

Related U.S. Application Data
(60) Provisional application No. 63/469,802, filed on May 30, 2023.

(51) Int. Cl. G05B 13/02

(52) U.S. Cl. CPC G05B 13/028

(57) ABSTRACT

An action generation method includes receiving, by one or more processors via a conversational interface, a query from a user, receiving, by the one or more processors, building subsystem data for one or more building subsystems in a building, retrieving, by the one or more processors, subject matter expert data, determining, by the one or more processors, an anomaly of the one or more building subsystems, based on the subject matter expert data and the building subsystem data, generating, by the one or more processors, a recommendation to resolve the anomaly based on fault detection and diagnostic (FDD) data related to a fault determined in the one or more building subsystems, and generating, by the one or more processors using a generative large language model, a response to the query based on the recommendation, the FDD data, and the subject matter expert data.

### CROSS-REFERENCE TO RELATED APPLICATIONS

This application claims the benefit of and priority to U.S. Provisional Patent Application No. 63/469,802, filed on May 30, 2023, the entirety of which is incorporated by reference herein.

### BACKGROUND

This application relates generally to a building system of a building. This application relates more particularly to systems for managing and processing data of the building system.

A building may aggregate and store building data received from building equipment and/or other data sources. The building data can be stored in a database. The building can include a building system that operates analytic and/or control algorithms against the data of the database to control the building equipment. However, the development and/or deployment of the analytic and/or control algorithms may be time consuming and require a significant amount of software development. Furthermore, the analytic and/or control algorithms may lack flexibility to adapt to changing circumstances in the building. In some cases, the output data of the analytic and/or control algorithms may be hard for a user to conceptualize and relate to the physical components of the building for which the information is generated.

### SUMMARY

One implementation is a method. The method includes receiving, by one or more processors via a conversational interface, a query from a user, receiving, by the one or more processors, building subsystem data for one or more building subsystems in a building, retrieving, by the one or more processors, subject matter expert data, determining, by the one or more processors, an anomaly of the one or more building subsystems, based on the subject matter expert data and the building subsystem data, generating, by the one or more processors, a recommendation to resolve the anomaly based on fault detection and diagnostic (FDD) data related to a fault determined in the one or more building subsystems, and generating, by the one or more processors using a generative large language model, a response to the query based on the recommendation, the FDD data, and the subject matter expert data.

One implementation is a system for generating a response to a query using a generative artificial intelligence model. The system includes one or more memory devices having instructions stored thereon that, when executed by one or more processors, cause the one or more processors to perform operations. The operations include receiving, via a conversational interface, a query from a user, receiving building subsystem data for one or more building subsystems in a building, retrieving subject matter expert data, determining an anomaly of the one or more building subsystems, based on the subject matter expert data and the building subsystem data, generating a recommendation to resolve the anomaly based on fault detection and diagnostic (FDD) data related to a fault determined in the one or more building subsystems, and generating, using a generative large language model, a response to the query based on the recommendation, the FDD data, and the subject matter expert data.

One implementation is one or more non-transitory computer-readable media. The one or more non-transitory computer-readable media stores program instructions that when executed cause the one or more processors to perform operations. The operations include receiving, via a conversational interface, a query from a user, receiving building subsystem data for one or more building subsystems in a building, retrieving subject matter expert data, determining an anomaly of the one or more building subsystems, based on the subject matter expert data and the building subsystem data, generating a recommendation to resolve the anomaly based on fault detection and diagnostic (FDD) data related to a fault determined in the one or more building subsystems, and generating, using a generative large language model, a response to the query based on the recommendation, the FDD data, and the subject matter expert data.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a drawing of a building equipped with a HVAC system, according to some embodiments.

FIG. 2 is a block diagram of an airside system that may be used in conjunction with the building of FIG. 1, according to some embodiments.

FIG. 3 is a block diagram of a building data platform including an edge platform, a cloud platform, and a twin manager, according to some embodiments.

FIG. 4 is a graph projection of the twin manager of FIG. 3 including equipment and capability data for the equipment, according to some embodiments.

FIG. 5 is a block diagram of a system for managing a digital twin where an artificial intelligence agent can be executed to infer information for an entity of a graph, according to some embodiments.

FIG. 6 is a block diagram of an example of a machine learning model-based system for equipment servicing applications, according to some embodiments.

FIG. 7 is a block diagram of an example of a language model-based system for equipment servicing applications, according to some embodiments.

FIG. 8 is a block diagram of an example of the system of FIG. 7 including user application session components, according to some embodiments.

FIG. 9 is a block diagram of an example of the system of FIG. 7 including feedback training components, according to some embodiments.

FIG. 10 is a block diagram of an example of the system of FIG. 7 including data filters, according to some embodiments.

FIG. 11 is a block diagram of an example of the system of FIG. 7 including data validation components, according to some embodiments.

FIG. 12 is a block diagram of an example of the system of FIG. 7 including expert review and intervention components, according to some embodiments.

FIG. 13 is a flow diagram of a method of generating a digital twin and/or knowledge graph using machine learning models, according to some embodiments.

FIG. 14 is a flow diagram of a method of reconfiguring building spaces using machine learning models, according to some embodiments.

FIG. 15 is a flow diagram of a method of generating and operating a conversational digital twin using machine learning models, according to some embodiments.

FIG. 16 is a block diagram of a system for generating a response to a user query using artificial intelligence, according to some embodiments.

FIG. 17 is a flow diagram of a method for generating a response to a user query using artificial intelligence, according to some embodiments.

### DETAILED DESCRIPTION

### Overview

Referring generally to the FIGURES, systems and methods in accordance with the present disclosure can implement various systems to precisely generate data relating to operations to be performed for managing building systems and components and/or items of equipment, including heating, ventilation, cooling, and/or refrigeration (HVAC-R) systems and components. For example, various systems described herein can be implemented to more precisely generate and manage digital twins for buildings and their associated building equipment.

The systems and methods described herein may include a digital twin manager which is configured to generate, store, and manage digital twins for one or more buildings and building equipment. A digital twin can store data representing entities (e.g., building devices, building equipment, building spaces, people associated with the building, etc.) and relationships between the building entities. The systems and methods described herein are configured to generate digital twins for the building automatically using a generative artificial intelligence (AI) model, such as a large language model (LLM). The systems and methods described herein may also be configured to generate a revised configuration for a building space using the generative AI model. In some embodiments, the revised configuration may be generated based on input received by the generative AI model from the user. For example, the systems and methods described herein may be configured to receive a query from a user regarding a building or a digital twin for the building. The digital twin manager may be configured to generate a response to the query by analyzing one or more digital twins for the building using a generative AI model.

AI and/or machine learning (ML) systems, including but not limited to LLMs, can be used to generate text data and data of other modalities in a more responsive manner to real-time conditions, including generating strings of text data that may not be provided in the same manner in existing documents, yet may still meet criteria for useful text information, such as relevance, style, and coherence. For example, LLMs can predict text data based at least on inputted prompts and by being configured (e.g., trained, modified, updated, fine-tuned) according to training data representative of the text data to predict or otherwise generate.

However, various considerations may limit the ability of such systems to precisely generate appropriate data for specific conditions. For example, due to the predictive nature of the generated data, some LLMs may generate text data that is incorrect, imprecise, or not relevant to the specific conditions. Using the LLMs may require a user to manually vary the content and/or syntax of inputs provided to the LLMs (e.g., vary inputted prompts) until the output of the LLMs meets various objective or subjective criteria of the user. The LLMs can have token limits for sizes of inputted text during training and/or runtime/inference operations (and relaxing or increasing such limits may require increased computational processing, API calls to LLM services, and/or memory usage), limiting the ability of the LLMs to be effectively configured or operated using large amounts of raw data or otherwise unstructured data.

Systems and methods in accordance with the present disclosure can use machine learning models, including LLMs and other generative AI systems, to capture data, including but not limited to unstructured knowledge from various data sources, and process the data to accurately generate outputs, such as completions responsive to prompts, including in structured data formats for various applications and use cases. The system can implement various automated and/or expert-based thresholds and data quality management processes to improve the accuracy and quality of generated outputs and update training of the machine learning models accordingly. The system can enable real-time messaging and/or conversational interfaces for users to provide field data regarding equipment to the system (including presenting targeted queries to users that are expected to elicit relevant responses for efficiently receiving useful response information from users) and guide users, such as service technicians, through relevant service, diagnostic, troubleshooting, and/or repair processes.

In some instances, significant computational resources (or human user resources) can be required to process data relating to equipment operation, such as time-series product data and/or sensor data, to detect or predict faults and/or causes of faults. In addition, it can be resource-intensive to label such data with identifiers of faults or causes of faults, which can make it difficult to generate machine learning training data from such data. Systems and methods in accordance with the present disclosure can leverage the efficiency of language models (e.g., GPT-based models or other pre-trained LLMs) in extracting semantic information (e.g., semantic information identifying faults, causes of faults, and other accurate expert knowledge regarding equipment servicing) from the unstructured data in order to use both the unstructured data and the data relating to equipment operation to generate more accurate outputs regarding equipment servicing. As such, by implementing language models using various operations and processes described herein, building management and equipment servicing systems can take advantage of the causal/semantic associations between the unstructured data and the data relating to equipment operation, and the language models can allow these systems to more efficiently extract these relationships in order to more accurately predict targeted, useful information for servicing applications at inference-time/runtime. While various implementations are described as being implemented using generative AI models such as transformers and/or GANs, in some embodiments, various features described herein can be implemented using non-generative AI models or even without using AI/machine learning, and all such modifications fall within the scope of the present disclosure.

In various implementations, the systems can include a plurality of machine learning models that may be configured using integrated or disparate data sources. This can facilitate more integrated user experiences or more specialized (and/or lower computational usage for) data processing and output generation. Outputs from one or more first systems, such as one or more first algorithms or machine learning models, can be provided at least as part of inputs to one or more second systems, such as one or more second algorithms or machine learning models. For example, a first language model can be configured to process unstructured inputs (e.g., text, speech, images, etc.) into a structure output format compatible for use by a second system, such as a root cause prediction algorithm or equipment configuration model.

The system can be used to automate interventions for equipment operation, servicing, fault detection and diagnostics (FDD), and alerting operations. For example, by being configured to perform operations such as root cause prediction, the system can monitor data regarding equipment to predict events associated with faults and trigger responses such as alerts, service scheduling, and initiating FDD or modifications to configuration of the equipment. The system can present to a technician or manager of the equipment a report regarding the intervention (e.g., action taken responsive to predicting a fault or root cause condition) and requesting feedback regarding the accuracy of the intervention, which can be used to update the machine learning models to more accurately generate interventions.

### Building HVAC Systems and Building Management Systems

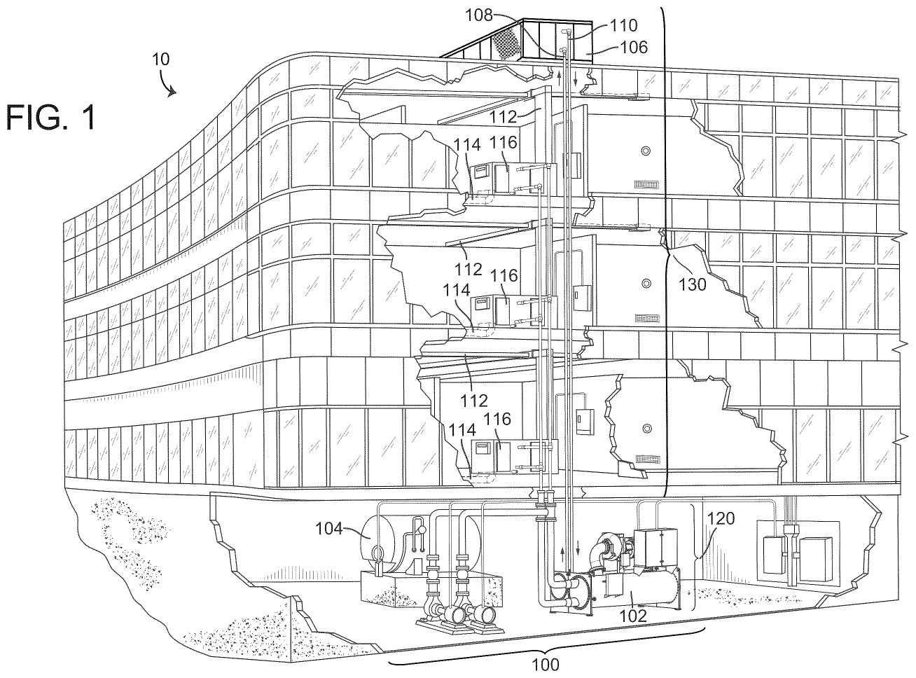

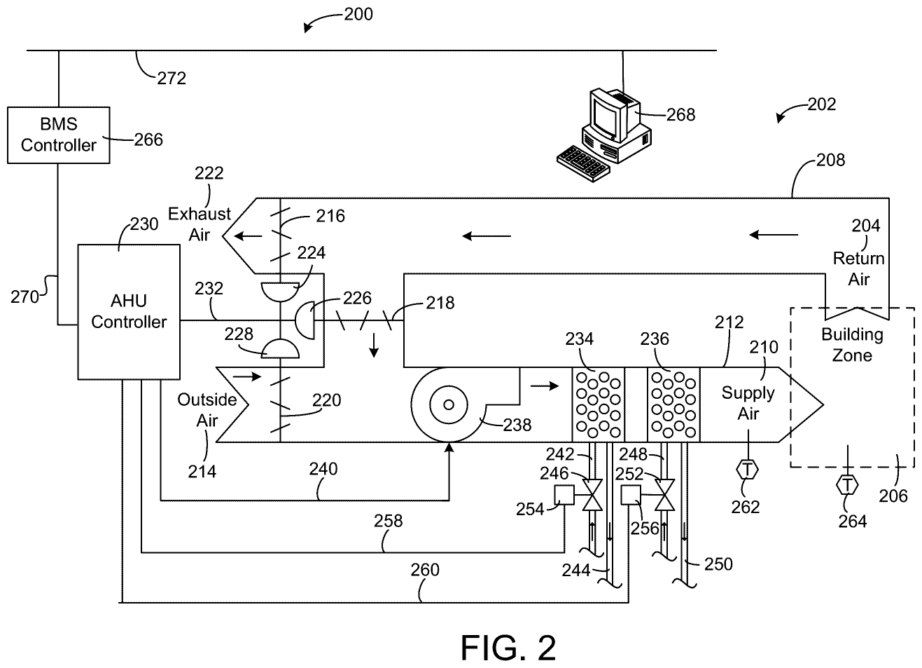

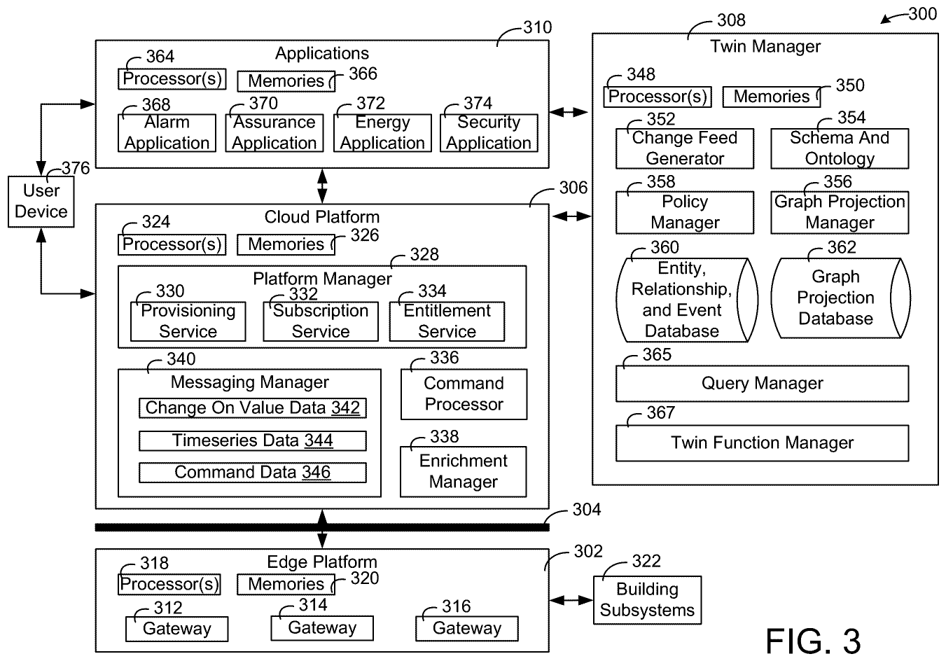

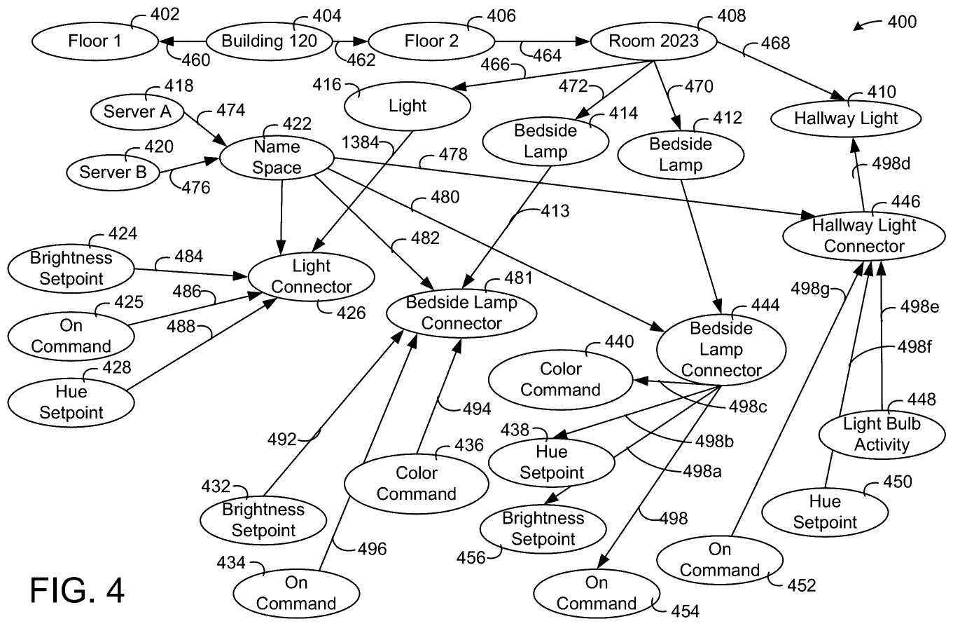

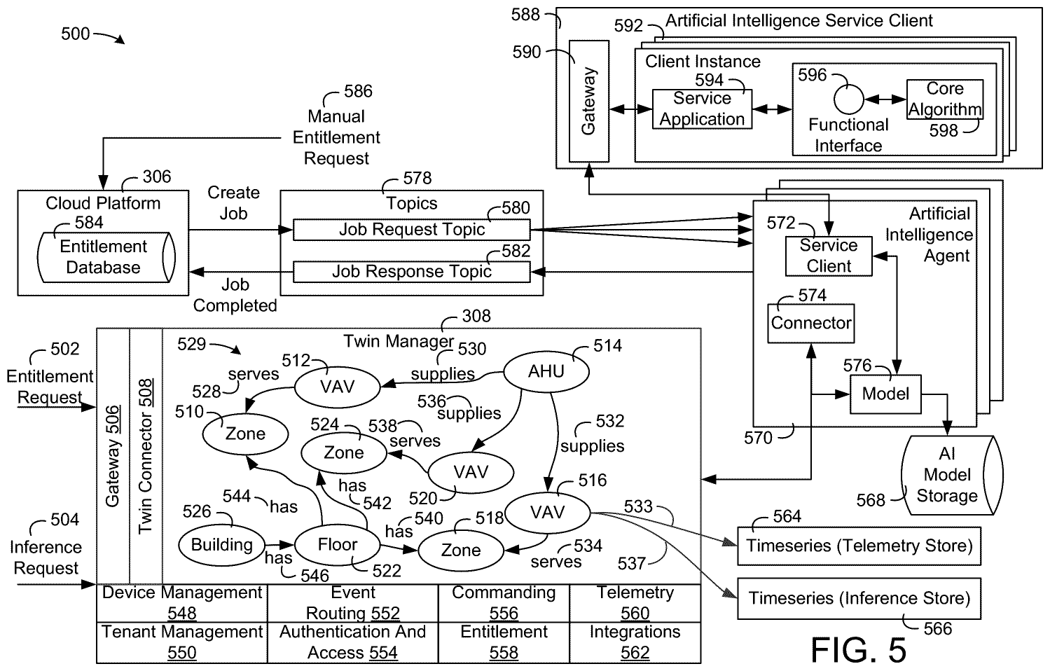

Referring now to FIGS. 1-5, several building management systems (BMS) and HVAC systems in which the systems and methods of the present disclosure can be implemented are shown, according to some embodiments. In brief overview, FIG. 1 shows a building 10 equipped with a HVAC system 100. FIG. 2 is a block diagram of an airside system 200 which can be used to serve building 10. FIG. 3 is a block diagram of a building data platform 300 which can be used to monitor and control building 10. FIG. 4 is a block diagram of a graph projection 400 of the twin manager of FIG. 3. FIG. 5 is a block diagram of a system 500 for managing the digital twins of FIG. 4.

Referring particularly to FIG. 1, a perspective view of a building 10 is shown. Building 10 is served by a BMS. A BMS is, in general, a system of devices configured to control, monitor, and manage equipment in or around a building or building area. A BMS can include, for example, a HVAC system, a security system, a lighting system, a fire safety system, any other system that can manage building functions or devices, or any combination thereof.

The BMS that serves building 10 includes an HVAC system 100. HVAC system 100 can include a plurality of HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 can provide a heated or chilled fluid to an air handling unit of airside system 130. Airside system 130 can use the heated or chilled fluid to heat or cool an airflow provided to building 10. An exemplary airside system which can be used in HVAC system 100 is described in greater detail with reference to FIG. 2.

HVAC system 100 is shown to include a chiller 102, a boiler 104, and a rooftop air handling unit (AHU) 106. Waterside system 120 can use boiler 104 and chiller 102 to heat or cool a working fluid (e.g., water, glycol, etc.) and can circulate the working fluid to AHU 106. In various embodiments, the HVAC devices of waterside system 120 can be located in or around building 10 (as shown in FIG. 1) or at an offsite location such as a central plant (e.g., a chiller plant, a steam plant, a heat plant, etc.). The working fluid can be heated in boiler 104 or cooled in chiller 102, depending on whether heating or cooling is required in building 10. Boiler 104 can add heat to the circulated fluid, for example, by burning a combustible material (e.g., natural gas) or using an electric heating element. Chiller 102 can place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 can be transported to AHU 106 via piping 108.

AHU 106 can place the working fluid in a heat exchange relationship with an airflow passing through AHU 106 (e.g., via one or more stages of cooling coils and/or heating coils). The airflow can be, for example, outside air, return air from within building 10, or a combination of both. AHU 106 can transfer heat between the airflow and the working fluid to provide heating or cooling for the airflow. For example, AHU 106 can include one or more fans or blowers configured to pass the airflow over or through a heat exchanger containing the working fluid. The working fluid can then return to chiller 102 or boiler 104 via piping 110.

Airside system 130 can deliver the airflow supplied by AHU 106 (i.e., the supply airflow) to building 10 via air supply ducts 112 and can provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 can include dampers or other flow control elements that can be operated to control an amount of the supply airflow provided to individual zones of building 10. In other embodiments, airside system 130 delivers the supply airflow into one or more zones of building 10 (e.g., via supply ducts 112) without using intermediate VAV units 116 or other flow control elements. AHU 106 can include various sensors (e.g., temperature sensors, pressure sensors, etc.) configured to measure attributes of the supply airflow. AHU 106 can receive input from sensors located within AHU 106 and/or within the building zone and can adjust the flow rate, temperature, or other attributes of the supply airflow through AHU 106 to achieve setpoint conditions for the building zone.

Referring now to FIG. 2, a block diagram of an airside system 200 is shown, according to some embodiments. In various embodiments, airside system 200 may supplement or replace airside system 130 in HVAC system 100 or may be implemented separate from HVAC system 100. When implemented in HVAC system 100, airside system 200 may include a subset of the HVAC devices in HVAC system 100 (e.g., AHU 106, VAV units 116, ducts 112-114, fans, dampers, etc.) and may be located in or around building 10. Airside system 200 may operate to heat or cool an airflow provided to building 10 using a heated or chilled fluid provided by a waterside system 120.

In FIG. 2, airside system 200 is shown to include an economizer-type air handling unit (AHU) 202. Economizer-type AHUs vary the amount of outside air and return air used by the air handling unit for heating or cooling. For example, AHU 202 may receive return air 204 from building zone 206 via return air duct 208 and may deliver supply air 210 to building zone 206 via supply air duct 212. In some embodiments, AHU 202 is a rooftop unit located on the roof of building 10 (e.g., AHU 106 as shown in FIG. 1) or otherwise positioned to receive both return air 204 and outside air 214. AHU 202 may be configured to operate exhaust air damper 216, mixing damper 218, and outside air damper 220 to control an amount of outside air 214 and return air 204 that combine to form supply air 210. Any return air 204 that does not pass through mixing damper 218 may be exhausted from AHU 202 through exhaust damper 216 as exhaust air 222.

Each of dampers 216-220 may be operated by an actuator. For example, exhaust air damper 216 may be operated by actuator 224, mixing damper 218 may be operated by actuator 226, and outside air damper 220 may be operated by actuator 228. Actuators 224-228 may communicate with an AHU controller 230 via a communications link 232. Actuators 224-228 may receive control signals from AHU controller 230 and may provide feedback signals to AHU controller 230. Feedback signals may include, for example, an indication of a current actuator or damper position, an amount of torque or force exerted by the actuator, diagnostic information (e.g., results of diagnostic tests performed by actuators 224-228), status information, commissioning information, configuration settings, calibration data, and/or other types of information or data that may be collected, stored, or used by actuators 224-228. AHU controller 230 may be an economizer controller configured to use one or more control algorithms (e.g., state-Based algorithms, extremum seeking control (ESC) algorithms, proportional-integral (PI) control algorithms, proportional-integral-derivative (PID) control algorithms, model predictive control (MPC) algorithms, feedback control algorithms, etc.) to control actuators 224-228.

Still referring to FIG. 2, AHU 202 is shown to include a cooling coil 234, a heating coil 236, and a fan 238 positioned within supply air duct 212. Fan 238 may be configured to force supply air 210 through cooling coil 234 and/or heating coil 236 and provide supply air 210 to building zone 206. AHU controller 230 may communicate with fan 238 via communications link 240 to control a flow rate of supply air 210. In some embodiments, AHU controller 230 controls an amount of heating or cooling applied to supply air 210 by modulating a speed of fan 238.

Cooling coil 234 may receive a chilled fluid from the waterside system (e.g., from cold water loop 216) via piping 242 and may return the chilled fluid to the waterside system via piping 244. Valve 246 may be positioned along piping 242 or piping 244 to control a flow rate of the chilled fluid through cooling coil 234. In some embodiments, cooling coil 234 includes multiple stages of cooling coils that can be independently activated and deactivated (e.g., by AHU controller 230, by BMS controller 266, etc.) to modulate an amount of cooling applied to supply air 210.

Heating coil 236 may receive a heated fluid from the waterside system (e.g., from hot water loop 214) via piping 248 and may return the heated fluid to the waterside system via piping 250. Valve 252 may be positioned along piping 248 or piping 250 to control a flow rate of the heated fluid through heating coil 236. In some embodiments, heating coil 236 includes multiple stages of heating coils that can be independently activated and deactivated (e.g., by AHU controller 230, by BMS controller 266, etc.) to modulate an amount of heating applied to supply air 210.

Each of valves 246 and 252 may be controlled by an actuator. For example, valve 246 may be controlled by actuator 254 and valve 252 may be controlled by actuator 256. Actuators 254-256 may communicate with AHU controller 230 via communications links 258-260. Actuators 254-256 may receive control signals from AHU controller 230 and may provide feedback signals to controller 230. In some embodiments, AHU controller 230 receives a measurement of the supply air temperature from a temperature sensor 262 positioned in supply air duct 212 (e.g., downstream of cooling coil 234 and/or heating coil 236). AHU controller 230 may also receive a measurement of the temperature of building zone 206 from a temperature sensor 264 located in building zone 206.

In some embodiments, AHU controller 230 operates valves 246 and 252 via actuators 254-256 to modulate an amount of heating or cooling provided to supply air 210 (e.g., to achieve a setpoint temperature for supply air 210 or to maintain the temperature of supply air 210 within a setpoint temperature range). The positions of valves 246 and 252 affect the amount of heating or cooling provided to supply air 210 by cooling coil 234 or heating coil 236 and may correlate with the amount of energy consumed to achieve a desired supply air temperature. AHU controller 230 may control the temperature of supply air 210 and/or building zone 206 by activating or deactivating coils 234-236, adjusting a speed of fan 238, or a combination of both.

Still referring to FIG. 2, airside system 200 is shown to include a building management system (BMS) controller 266 and a client device 268. BMS controller 266 may include one or more computer systems (e.g., servers, supervisory controllers, subsystem controllers, etc.) that serve as system level controllers, application or data servers, head nodes, or master controllers for airside system 200, HVAC system 100, and/or other controllable systems that serve building 10. BMS controller 266 may communicate with multiple downstream building systems or subsystems (e.g., HVAC system 100, a security system, a lighting system, etc.) via a communications link 270 according to like or disparate protocols (e.g., LON, BACnet, etc.). In various embodiments, AHU controller 230 and BMS controller 266 may be separate (as shown in FIG. 2) or integrated. In an integrated implementation, AHU controller 230 may be a software module configured for execution by a processor of BMS controller 266.

In some embodiments, AHU controller 230 receives information from BMS controller 266 (e.g., commands, setpoints, operating boundaries, etc.) and provides information to BMS controller 266 (e.g., temperature measurements, valve or actuator positions, operating statuses, diagnostics, etc.). For example, AHU controller 230 may provide BMS controller 266 with temperature measurements from temperature sensors 262-264, equipment on/off states, equipment operating capacities, and/or any other information that can be used by BMS controller 266 to monitor or control a variable state or condition within building zone 206.

Client device 268 may include one or more human-machine interfaces or client interfaces (e.g., graphical user interfaces, reporting interfaces, text-Based computer interfaces, client-facing web services, web servers that provide pages to web clients, etc.) for controlling, viewing, or otherwise interacting with HVAC system 100, its subsystems, and/or devices. Client device 268 may be a computer workstation, a client terminal, a remote or local interface, or any other type of user interface device. Client device 268 may be a stationary terminal or a mobile device. For example, client device 268 may be a desktop computer, a computer server with a user interface, a laptop computer, a tablet, a smartphone, a PDA, or any other type of mobile or non-mobile device. Client device 268 may communicate with BMS controller 266 and/or AHU controller 230 via communications link 272.

Referring now to FIG. 3, a building data platform 300 including an edge platform 302, a cloud platform 306, and a twin manager 308 are shown, according to an exemplary embodiment. The edge platform 302, the cloud platform 306, and the twin manager 308 can each be separate services deployed on the same or different computing systems. In some embodiments, the cloud platform 306 and the twin manager 308 are implemented in off premises computing systems, e.g., outside a building. The edge platform 302 can be implemented on-premises, e.g., within the building. However, any combination of on-premises and off-premises components of the building data platform 300 can be implemented.

The building data platform 300 includes applications 310. The applications 310 can be various applications that operate to manage the building subsystems 322. The applications 310 can be remote or on-premises applications (or a hybrid of both) that run on various computing systems. The applications 310 can include an alarm application 368 configured to manage alarms for the building subsystems 322. The applications 310 include an assurance application 370 that implements assurance services for the building subsystems 322. In some embodiments, the applications 310 include an energy application 372 configured to manage the energy usage of the building subsystems 322. The applications 310 include a security application 374 configured to manage security systems of the building.

In some embodiments, the applications 310 and/or the cloud platform 306 interacts with a user device 376. In some embodiments, a component or an entire application of the applications 310 runs on the user device 376. The user device 376 may be a laptop computer, a desktop computer, a smartphone, a tablet, and/or any other device with an input interface (e.g., touch screen, mouse, keyboard, etc.) and an output interface (e.g., a speaker, a display, etc.).

The applications 310, the twin manager 308, the cloud platform 306, and the edge platform 302 can be implemented on one or more computing systems, e.g., on processors and/or memory devices. For example, the edge platform 302 includes processor(s) 318 and memories 320, the cloud platform 306 includes processor(s) 324 and memories 326, the applications 310 include processor(s) 364 and memories 366, and the twin manager 308 includes processor(s) 348 and memories 350.

The processors can be a general purpose or specific purpose processors, an application specific integrated circuit (ASIC), one or more field programmable gate arrays (FPGAs), a group of processing components, or other suitable processing components. The processors may be configured to execute computer code and/or instructions stored in the memories or received from other computer readable media (e.g., CDROM, network storage, a remote server, etc.).

The memories can include one or more devices (e.g., memory units, memory devices, storage devices, etc.) for storing data and/or computer code for completing and/or facilitating the various processes described in the present disclosure. The memories can include random access memory (RAM), read-only memory (ROM), hard drive storage, temporary storage, non-volatile memory, flash memory, optical memory, or any other suitable memory for storing software objects and/or computer instructions. The memories can include database components, object code components, script components, or any other type of information structure for supporting the various activities and information structures described in the present disclosure. The memories can be communicably connected to the processors and can include computer code for executing (e.g., by the processors) one or more processes described herein.

The edge platform 302 can be configured to provide connection to the building subsystems 322. The edge platform 302 can receive messages from the building subsystems 322 and/or deliver messages to the building subsystems 322. The edge platform 302 includes one or multiple gateways, e.g., the gateways 312-316. The gateways 312-316 can act as a gateway between the cloud platform 306 and the building subsystems 322. The gateways 312-316 can be the gateways described in U.S. Provisional Patent Application No. 62/951,897 filed Dec. 20, 2019, the entirety of which is incorporated by reference herein. In some embodiments, the applications 310 can be deployed on the edge platform 302. In this regard, lower latency in management of the building subsystems 322 can be realized.

The edge platform 302 can be connected to the cloud platform 306 via a network 304. The network 304 can communicatively couple the devices and systems of building data platform 300. In some embodiments, the network 304 is at least one of and/or a combination of a Wi-Fi network, a wired Ethernet network, a ZigBee network, a Bluetooth network, and/or any other wireless network. The network 304 may be a local area network or a wide area network (e.g., the Internet, a building WAN, etc.) and may use a variety of communications protocols (e.g., BACnet, IP, LON, etc.). The network 304 may include routers, modems, servers, cell towers, satellites, and/or network switches. The network 304 may be a combination of wired and wireless networks.

The cloud platform 306 can be configured to facilitate communication and routing of messages between the applications 310, the twin manager 308, the edge platform 302, and/or any other system. The cloud platform 306 can include a platform manager 328, a messaging manager 340, a command processor 336, and an enrichment manager 338. In some embodiments, the cloud platform 306 can facilitate messaging between the building data platform 300 via the network 304.

The messaging manager 340 can be configured to operate as a transport service that controls communication with the building subsystems 322 and/or any other system, e.g., managing commands to devices (C2D), commands to connectors (C2C) for external systems, commands from the device to the cloud (D2C), and/or notifications. The messaging manager 340 can receive different types of data from the applications 310, the twin manager 308, and/or the edge platform 302. The messaging manager 340 can receive change on value data 342, e.g., data that indicates that a value of a point has changed. The messaging manager 340 can receive timeseries data 344, e.g., a time correlated series of data entries each associated with a particular time stamp. Furthermore, the messaging manager 340 can receive command data 346. All of the messages handled by the cloud platform 306 can be handled as an event, e.g., the data 342-346 can each be packaged as an event with a data value occurring at a particular time (e.g., a temperature measurement made at a particular time).

The cloud platform 306 includes a command processor 336. The command processor 336 can be configured to receive commands to perform an action from the applications 310, the building subsystems 322, the user device 376, etc. The command processor 336 can manage the commands, determine whether the commanding system is authorized to perform the particular commands, and communicate the commands to the commanded system, e.g., the building subsystems 322 and/or the applications 310. The commands could be a command to change an operational setting that control environmental conditions of a building, a command to run analytics, etc.

The cloud platform 306 includes an enrichment manager 338. The enrichment manager 338 can be configured to enrich the events received by the messaging manager 340. The enrichment manager 338 can be configured to add contextual information to the events. The enrichment manager 338 can communicate with the twin manager 308 to retrieve the contextual information. In some embodiments, the contextual information is an indication of information related to the event. For example, if the event is a timeseries temperature measurement of a thermostat, contextual information such as the location of the thermostat (e.g., what room), the equipment controlled by the thermostat (e.g., what VAV), etc. can be added to the event. In this regard, when a consuming application, e.g., one of the applications 310 receives the event, the consuming application can operate based on the data of the event, the temperature measurement, and also the contextual information of the event.

The enrichment manager 338 can solve a problem that when a device produces a significant amount of information, the information may contain simple data without context. An example might include the data generated when a user scans a badge at a badge scanner of the building subsystems 322. This physical event can generate an output event including such information as “DeviceBadgeScannerID,” “BadgeID,” and/or “Date/Time.” However, if a system sends this data to a consuming application, e.g., Consumer A and a Consumer B, each customer may need to call the building data platform knowledge service to query information with queries such as, “What space, building, floor is that badge scanner in?” or “What user is associated with that badge?”

By performing enrichment on the data feed, a system can be able to perform inferences on the data. A result of the enrichment may be transformation of the message “DeviceBadgeScannerId, BadgeId, Date/Time,” to “Region, Building, Floor, Asset, DeviceId, BadgeId, UserName, EmployeeId, Date/Time Scanned.” This can be a significant optimization, as a system can reduce the number of calls by 1/n, where n is the number of consumers of this data feed.

By using this enrichment, a system can also have the ability to filter out undesired events. If there are 100 buildings in a campus that receive 100,000 events per building each hour, but only 1 building is actually commissioned, only 1/10 of the events are enriched. By looking at what events are enriched and what events are not enriched, a system can do traffic shaping of forwarding of these events to reduce the cost of forwarding events that no consuming application wants or reads.

An example of an event received by the enrichment manager 338 may be:

```
    {
“id”: “someguid”,
  “eventType”: “Device_Heartbeat”,
  “eventTime”: “2018-01-27T00:00:00+00:00”
  “eventValue”: 1,
  “deviceID”: “someguid”
      }
```

An example of an enriched event generated by the enrichment manager 338 may be:

```
  {
“id”: “someguid”,
“eventType”: “Device_Heartbeat”,
“eventTime”: “2018-01-27T00:00:00+00:00”
“eventValue”: 1,
“deviceID”: “someguid”,
“buildingName”: “Building-48”,
“buildingID”: “SomeGuid”,
“panelID”: “SomeGuid”,
“panelName”: “Building-48-Panel-13”,
“cityID”: 371,
“cityName”: “Milwaukee”,
“stateID”: 48,
“stateName”: “Wisconsin (WI)”,
“countryID”: 1,
“countryName”: “United States”
  }
```

By receiving enriched events, an application of the applications 310 can be able to populate and/or filter what events are associated with what areas. Furthermore, user interface generating applications can generate user interfaces that include the contextual information based on the enriched events.

The cloud platform 306 includes a platform manager 328. The platform manager 328 can be configured to manage the users and/or subscriptions of the cloud platform 306. For example, what subscribing building, user, and/or tenant utilizes the cloud platform 306. The platform manager 328 includes a provisioning service 330 configured to provision the cloud platform 306, the edge platform 302, and the twin manager 308. The platform manager 328 includes a subscription service 332 configured to manage a subscription of the building, user, and/or tenant while the entitlement service 334 can track entitlements of the buildings, users, and/or tenants.

The twin manager 308 can be configured to manage and maintain a digital twin. The digital twin can be a digital representation of the physical environment, e.g., a building. The twin manager 308 can include a change feed generator 352, a schema and ontology 354, a projection manager 356, a policy manager 358, an entity, relationship, and event database 360, and a graph projection database 362.

The graph projection manager 356 can be configured to construct graph projections and store the graph projections in the graph projection database 362. Entities, relationships, and events can be stored in the database 360. The graph projection manager 356 can retrieve entities, relationships, and/or events from the database 360 and construct a graph projection based on the retrieved entities, relationships and/or events. In some embodiments, the database 360 includes an entity-relationship collection for multiple subscriptions.

In some embodiments, the graph projection manager 356 generates a graph projection for a particular user, application, subscription, and/or system. In this regard, the graph projection can be generated based on policies for the particular user, application, and/or system in addition to an ontology specific for that user, application, and/or system. In this regard, an entity could request a graph projection and the graph projection manager 356 can be configured to generate the graph projection for the entity based on policies and an ontology specific to the entity. The policies can indicate what entities, relationships, and/or events the entity has access to. The ontology can indicate what types of relationships between entities the requesting entity expects to see, e.g., floors within a building, devices within a floor, etc. Another requesting entity may have an ontology to see devices within a building and applications for the devices within the graph.

The graph projections generated by the graph projection manager 356 and stored in the graph projection database 362 can be a knowledge graph and is an integration point. For example, the graph projections can represent floor plans and systems associated with each floor. Furthermore, the graph projections can include events, e.g., telemetry data of the building subsystems 322. The graph projections can show application services as nodes and API calls between the services as edges in the graph. The graph projections can illustrate the capabilities of spaces, users, and/or devices. The graph projections can include indications of the building subsystems 322, e.g., thermostats, cameras, VAVs, etc. The graph projection database 362 can store graph projections that keep up a current state of a building.

The graph projections of the graph projection database 362 can be digital twins of a building. Digital twins can be digital replicas of physical entities that enable an in-depth analysis of data of the physical entities and provide the potential to monitor systems to mitigate risks, manage issues, and utilize simulations to test future solutions. Digital twins can play an important role in helping technicians find the root cause of issues and solve problems faster, in supporting safety and security protocols, and in supporting building managers in more efficient use of energy and other facilities resources. Digital twins can be used to enable and unify security systems, employee experience, facilities management, sustainability, etc.

In some embodiments the enrichment manager 338 can use a graph projection of the graph projection database 362 to enrich events. In some embodiments, the enrichment manager 338 can identify nodes and relationships that are associated with, and are pertinent to, the device that generated the event. For example, the enrichment manager 338 could identify a thermostat generating a temperature measurement event within the graph. The enrichment manager 338 can identify relationships between the thermostat and spaces, e.g., a zone that the thermostat is located in. The enrichment manager 338 can add an indication of the zone to the event.

Furthermore, the command processor 336 can be configured to utilize the graph projections to command the building subsystems 322. The command processor 336 can identify a policy for a commanding entity within the graph projection to determine whether the commanding entity has the ability to make the command. For example, the command processor 336, before allowing a user to make a command, determine, based on the graph projection database 362, to determine that the user has a policy to be able to make the command.

In some embodiments, the policies can be conditional based policies. For example, the building data platform 300 can apply one or more conditional rules to determine whether a particular system has the ability to perform an action. In some embodiments, the rules analyze a behavioral based biometric. For example, a behavioral based biometric can indicate normal behavior and/or normal behavior rules for a system. In some embodiments, when the building data platform 300 determines, based on the one or more conditional rules, that an action requested by a system does not match a normal behavior, the building data platform 300 can deny the system the ability to perform the action and/or request approval from a higher level system.

For example, a behavior rule could indicate that a user has access to log into a system with a particular IP address between 8 A.M. through 5 P.M. However, if the user logs in to the system at 7 P.M., the building data platform 300 may contact an administrator to determine whether to give the user permission to log in.

The change feed generator 352 can be configured to generate a feed of events that indicate changes to the digital twin, e.g., to the graph. The change feed generator 352 can track changes to the entities, relationships, and/or events of the graph. For example, the change feed generator 352 can detect an addition, deletion, and/or modification of a node or edge of the graph, e.g., changing the entities, relationships, and/or events within the database 360. In response to detecting a change to the graph, the change feed generator 352 can generate an event summarizing the change. The event can indicate what nodes and/or edges have changed and how the nodes and edges have changed. The events can be posted to a topic by the change feed generator 352.

The change feed generator 352 can implement a change feed of a knowledge graph. The building data platform 300 can implement a subscription to changes in the knowledge graph. When the change feed generator 352 posts events in the change feed, subscribing systems or applications can receive the change feed event. By generating a record of all changes that have happened, a system can stage data in different ways, and then replay the data back in whatever order the system wishes. This can include running the changes sequentially one by one and/or by jumping from one major change to the next. For example, to generate a graph at a particular time, all change feed events up to the particular time can be used to construct the graph.

The change feed can track the changes in each node in the graph and the relationships related to them, in some embodiments. If a user wants to subscribe to these changes and the user has proper access, the user can simply submit a web API call to have sequential notifications of each change that happens in the graph. A user and/or system can replay the changes one by one to reinstitute the graph at any given time slice. Even though the messages are “thin” and only include notification of change and the reference “id/seq id,” the change feed can keep a copy of every state of each node and/or relationship so that a user and/or system can retrieve those past states at any time for each node. Furthermore, a consumer of the change feed could also create dynamic “views” allowing different “snapshots” in time of what the graph looks like from a particular context. While the twin manager 308 may contain the history and the current state of the graph based upon schema evaluation, a consumer can retain a copy of that data, and thereby create dynamic views using the change feed.

The schema and ontology 354 can define the message schema and graph ontology of the twin manager 308. The message schema can define what format messages received by the messaging manager 340 should have, e.g., what parameters, what formats, etc. The ontology can define graph projections, e.g., the ontology that a user wishes to view. For example, various systems, applications, and/or users can be associated with a graph ontology. Accordingly, when the graph projection manager 356 generates an graph projection for a user, system, or subscription, the graph projection manager 356 can generate a graph projection according to the ontology specific to the user. For example, the ontology can define what types of entities are related in what order in a graph, for example, for the ontology for a subscription of “Customer A,” the graph projection manager 356 can create relationships for a graph projection based on the rule:
Region [symbol] Buildi [symbol] Floor [symbol] Space [symbol] Asset

For the ontology of a subscription of “Customer B,” the graph projection manager 356 can create relationships based on the rule:
Building [symbol] Floor [symbol] Asset

The policy manager 358 can be configured to respond to requests from other applications and/or systems for policies. The policy manager 358 can consult a graph projection to determine what permissions different applications, users, and/or devices have. The graph projection can indicate various permissions that different types of entities have and the policy manager 358 can search the graph projection to identify the permissions of a particular entity. The policy manager 358 can facilitate fine grain access control with user permissions. The policy manager 358 can apply permissions across a graph, e.g., if “user can view all data associated with floor 1” then they see all subsystem data for that floor, e.g., surveillance cameras, HVAC devices, fire detection and response devices, etc.

The twin manager 308 includes a query manager 365 and a twin function manager 367. The query manger 364 can be configured to handle queries received from a requesting system, e.g., the user device 376, the applications 310, and/or any other system. The query manager 365 can receive queries that include query parameters and context. The query manager 365 can query the graph projection database 362 with the query parameters to retrieve a result. The query manager 365 can then cause an event processor, e.g., a twin function, to operate based on the result and the context. In some embodiments, the query manager 365 can select the twin function based on the context and/or perform operates based on the context. In some embodiments, the query manager 365 is configured to perform the operations described with reference to FIGS. 4-16.

The twin function manager 367 can be configured to manage the execution of twin functions. The twin function manager 367 can receive an indication of a context query that identifies a particular data element and/or pattern in the graph projection database 362. Responsive to the particular data element and/or pattern occurring in the graph projection database 362 (e.g., based on a new data event added to the graph projection database 362 and/or change to nodes or edges of the graph projection database 362, the twin function manager 367 can cause a particular twin function to execute. The twin function can execute based on an event, context, and/or rules. The event can be data that the twin function executes against. The context can be information that provides a contextual description of the data, e.g., what device the event is associated with, what control point should be updated based on the event, etc.

Referring now to FIG. 4, a graph projection 400 of the twin manager 308 including equipment and capability data for the equipment is shown, according to an exemplary embodiment. The graph projection 400 includes nodes 402-456 and edges 360-498f. The cloud platform 306 can search the graph projection 400 to identify capabilities of different pieces of equipment.

A building node 404 represents a particular building that includes two floors. A floor 1 node 402 is linked to the building node 404 via edge 460 while a floor 2 node 406 is linked to the building node 404 via edge 462. The floor 2 includes a particular room 2023 represented by edge 464 between floor 2 node 406 and room 2023 node 408. Various pieces of equipment are included within the room 2023. A light represented by light node 416, a bedside lamp node 414, a bedside lamp node 412, and a hallway light node 410 are related to room 2023 node 408 via edge 466, edge 472, edge 470, and edge 468.

The light represented by light node 416 is related to a light connector 426 via edge 484. The light connector 426 is related to multiple commands for the light represented by the light node 416 via edges 484, 486, and 488. The commands may be a brightness setpoint 424, an on command 425, and a hue setpoint 428. The cloud platform 306 can receive a request to identify commands for the light represented by the light 416 and can identify the nodes 424-428 and provide an indication of the commands represented by the node 424-428 to the requesting entity. The requesting entity can then send commands for the commands represented by the nodes 424-428.

The bedside lamp node 414 is linked to a bedside lamp connector 481 via an edge 413. The connector 481 is related to commands for the bedside lamp represented by the bedside lamp node 414 via edges 492, 496, and 494. The command nodes are a brightness setpoint node 432, an on command node 434, and a color command 436. The hallway light 410 is related to a hallway light connector 446 via an edge 498d. The hallway light connector 446 is linked to multiple commands for the hallway light node 410 via edges 498g, 498f, and 498c. The commands are represented by an on command node 452, a hue setpoint node 450, and a light bulb activity node 448.

The graph projection 400 includes a name space node 422 related to a server A node 418 and a server B node 420 via edges 474 and 476. The name space node 422 is related to the bedside lamp connector 481, the bedside lamp connector 444, and the hallway light connector 446 via edges 482, 480, and 478. The bedside lamp connector 444 is related to commands, e.g., the color command node 440, the hue setpoint command 438, a brightness setpoint command 456, and an on command 454 via edges 498c, 498b, 498a, and 498.

Referring now to FIG. 5, a system 500 for managing a digital twin where an artificial intelligence agent can be executed to infer and/or predict information for an entity of a graph is shown, according to an exemplary embodiment. The system 500 can be components of the building data platform 300, e.g., components run on the processors and memories of the edge platform 302, the cloud platform 306, the twin manager 308, and/or the applications 310. The system 500 can, in some implementations, implement a digital twin with artificial intelligence.

A digital twin (or a shadow) may be a computing entity that describes a physical thing (e.g., a building, spaces of a building, devices of a building, people of the building, equipment of the building, etc.) through modeling the physical thing through a set of attributes that define the physical thing. A digital twin can refer to a digital replica of physical assets (a physical device twin) and can be extended to store processes, people, places, systems that can be used for various purposes. The digital twin can include both the ingestion of information and actions learned and executed through artificial intelligence agents.

In FIG. 5, the digital twin can be a graph 529 managed by the twin manager 308 and/or artificial intelligence agents 570. In some embodiments, the digital twin is the combination of the graph 529 with the artificial intelligence agents 570. In some embodiments, the digital twin enables the creation of a chronological time-series database of telemetry events for analytical purposes. In some embodiments, the graph 529 uses the BRICK schema.

The twin manager 308 stores the graph 529 which may be a graph data structure including various nodes and edges interrelating the nodes. The graph 529 may be the same as, or similar to, the graph projections described herein with reference to FIGS. 1-4. The graph 529 includes nodes 510-526 and edges 528-546. The graph 529 includes a building node 526 representing a building that has a floor indicated by the “has” edge 546 to the floor node 522. The floor node 522 is relate to a zone node 510 via a “has” edge 544 indicating that the floor represented by the node 522 has a zone represented by the zone 510.

The floor node 522 is related to the zone node 518 by the “has” edge 540 indicating that the floor represented by the floor node 522 has another zone represented by the zone node 518. The floor node 522 is related to another zone node 524 via a “has” edge 542 representing that the floor represented by the floor node 522 has a third zone represented by the zone node 524.

The graph 529 includes an AHU node 514 representing an AHU of the building represented by the building node 526. The AHU node 514 is related by a “supplies” edge 530 to the VAV node 512 to represent that the AHU represented by the AHU node 514 supplies air to the VAV represented by the VAV node 512. The AHU node 514 is related by a “supplies” edge 536 to the VAV node 520 to represent that the AHU represented by the AHU node 514 supplies air to the VAV represented by the VAV node 520. The AHU node 514 is related by a “supplies” edge 532 to the VAV node 516 to represent that the AHU represented by the AHU node 514 supplies air to the VAV represented by the VAV node 516.

The VAV node 516 is related to the zone node 518 via the “serves” edge 534 to represent that the VAV represented by the VAV node 516 serves (e.g., heats or cools) the zone represented by the zone node 518. The VAV node 520 is related to the zone node 524 via the “serves” edge 538 to represent that the VAV represented by the VAV node 520 serves (e.g., heats or cools) the zone represented by the zone node 524. The VAV node 512 is related to the zone node 510 via the “serves” edge 528 to represent that the VAV represented by the VAV node 512 serves (e.g., heats or cools) the zone represented by the zone node 510.

Furthermore, the graph 529 includes an edge 533 related to a timeseries node 564. The timeseries node 564 can be information stored within the graph 529 and/or can be information stored outside the graph 529 in a different database (e.g., a timeseries database). In some embodiments, the timeseries node 564 stores timeseries data (or any other type of data) for a data point of the VAV represented by the VAV node 516. The data of the timeseries node 564 can be aggregated and/or collected telemetry data of the timeseries node 564.

Furthermore, the graph 529 includes an edge 537 related to a timeseries node 566. The timeseries node 566 can be information stored within the graph 529 and/or can be information stored outside the graph 529 in a different database (e.g., a timeseries database). In some embodiments, the timeseries node 566 stores timeseries data (or any other type of data) for a data point of the VAV represented by the VAV node 516. The data of the timeseries node 564 can be inferred information, e.g., data inferred by one of the artificial intelligence agents 570 and written into the timeseries node 564 by the artificial intelligence agent 570. In some embodiments, the timeseries 564 and/or 566 are stored in the graph 529 but are stored as references to timeseries data stored in a timeseries database.

The twin manager 308 includes various software components. For example, the twin manager 308 includes a device management component 548 for managing devices of a building. The twin manager 308 includes a tenant management component 550 for managing various tenant subscriptions. The twin manager 308 includes an event routing component 552 for routing various events. The twin manager 308 includes an authentication and access component 554 for performing user and/or system authentication and granting the user and/or system access to various spaces, pieces of software, devices, etc. The twin manager 308 includes a commanding component 556 allowing a software application and/or user to send commands to physical devices. The twin manager 308 includes an entitlement component 558 that analyzes the entitlements of a user and/or system and grants the user and/or system abilities based on the entitlements. The twin manager 308 includes a telemetry component 560 that can receive telemetry data from physical systems and/or devices and ingest the telemetry data into the graph 529. Furthermore, the twin manager 308 includes an integrations component 562 allowing the twin manager 308 to integrate with other applications.

The twin manager 308 includes a gateway 506 and a twin connector 508. The gateway 506 can be configured to integrate with other systems and the twin connector 508 can be configured to allow the gateway 506 to integrate with the twin manager 308. The gateway 506 and/or the twin connector 508 can receive an entitlement request 502 and/or an inference request 504. The entitlement request 502 can be a request received from a system and/or a user requesting that an AI agent action be taken by the AI agent 570. The entitlement request 502 can be checked against entitlements for the system and/or user to verify that the action requested by the system and/or user is allowed for the user and/or system. The inference request 504 can be a request that the AI agent 570 generates an inference, e.g., a projection of information, a prediction of a future data measurement, an extrapolated data value, etc.

The cloud platform 306 is shown to receive a manual entitlement request 586. The request 586 can be received from a system, application, and/or user device (e.g., from the applications 310, the building subsystems 322, and/or the user device 176). The manual entitlement request 586 may be a request for the AI agent 570 to perform an action, e.g., an action that the requesting system and/or user has an entitlement for. The cloud platform 306 can receive the manual entitlement request 586 and check the manual entitlement request 586 against an entitlement database 584 storing a set of entitlements to verify that the requesting system has access to the user and/or system. The cloud platform 306, responsive to the manual entitlement request 586 being approved, can create a job for the AI agent 570 to perform. The created job can be added to a job request topic 580 of a set of topics 578.

The job request topic 580 can be fed to AI agents 570. For example, the topics 580 can be fanned out to various AI agents 570 based on the AI agent that each of the topics 580 pertains to (e.g., based on an identifier that identifies an agent and is included in each job of the topic 580). The AI agents 570 include a service client 572, a connector 574, and a model 576. The model 576 can be loaded into the AI agent 570 from a set of AI models stored in the AI model storage 568. The AI model storage 568 can store models for making energy load predictions for a building, weather forecasting models for predicting a weather forecast, action/decision models to take certain actions responsive to certain conditions being met, an occupancy model for predicting occupancy of a space and/or a building, etc. In some embodiments, the occupancy level may be a numerical value that indicates the amount of people within the building (e.g., total number, portion of the building capacity, scale between 1 (empty) and 10 (full), etc.). In some embodiments, the occupancy level may be a non-numerical indicator that indicates the amount of people within the building such as occupancy descriptors (e.g., “Empty”, “Half-Full”, “Full”). The models of the AI model storage 568 can be neural networks (e.g., convolutional neural networks, recurrent neural networks, deep learning networks, etc.), decision trees, support vector machines, and/or any other type of artificial intelligence, machine learning, and/or deep learning category.

The AI agent 570 can include a service client 572 that causes an instance of an AI agent to run. The instance can be hosted by the artificial intelligence service client 588. The client 588 can cause a client instance 592 to run and communicate with the AI agent 570 via a gateway 590. The client instance 592 can include a service application 594 that interfaces with a core algorithm 598 via a functional interface 596. The core algorithm 598 can run the model 576, e.g., train the model 576 and/or use the model 576 to make inferences and/or predictions.

In some embodiments, the core algorithm 598 can be configured to perform learning based on the graph 529. In some embodiments, the core algorithm 598 can read and/or analyze the nodes and relationships of the graph 529 to make decisions. In some embodiments, the core algorithm 598 can be configured to use telemetry data (e.g., the timeseries data 564) from the graph 529 to make inferences on and/or perform model learning. In some embodiments, the result of the inferences can be the timeseries 566. In some embodiments, the timeseries 564 is an input into the model 576 that predicts the timeseries 566.

In some embodiments, the core algorithm 598 can generate the timeseries 566 as an inference for a data point, e.g., a prediction of values for the data point at future times. The timeseries 564 may be actual data for the data point. In this regard, the core algorithm 598 can learn and train by comparing the inferred data values against the true data values. In this regard, the model 576 can be trained by the core algorithm 598 to improve the inferences made by the model 576.

### Machine Learning Models for Building Management

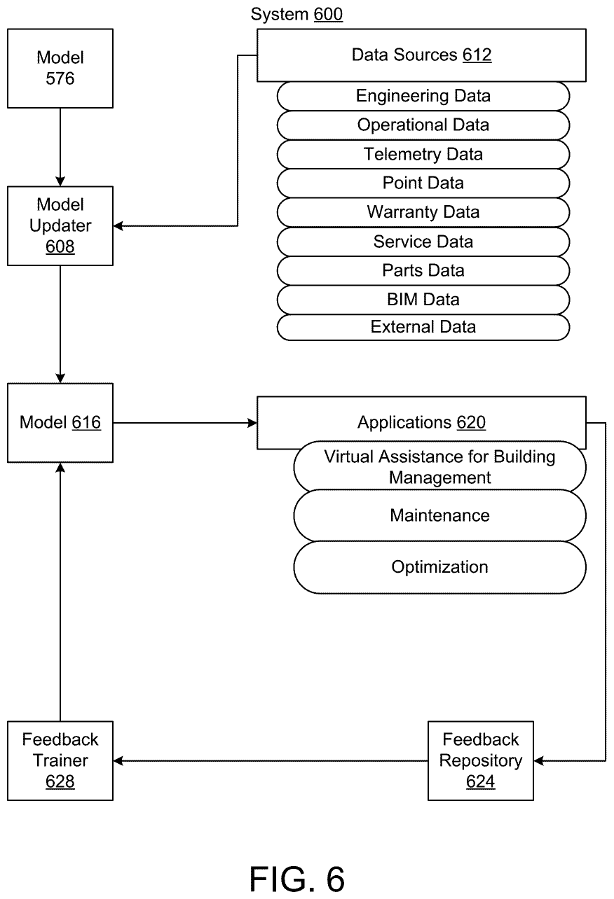

FIG. 6 depicts an example of a system 600. The system 600 can implement various operations for configuring (e.g., training, updating, modifying, transfer learning, fine-tuning, etc.) and/or operating various AI and/or ML systems, such as neural networks of large language models (LLMs) or other generative AI systems. The system 600 can be used to implement various generative AI-based building equipment servicing operations.

For example, the system 600 can be implemented for operations associated with any of a variety of building management systems (BMSs) or equipment or components thereof. A BMS can include a system of devices that can control, monitor, and manage equipment in or around a building or building area. The BMS can include, for example, a HVAC system, a security system, a lighting system, a fire alerting system, any other system that is capable of managing building functions or devices, or any combination thereof. The BMS can include or be coupled with items of equipment, for example and without limitation, such as heaters, chillers, boilers, air handling units, sensors, actuators, refrigeration systems, fans, blowers, heat exchangers, energy storage devices, condensers, valves, or various combinations thereof.

The items of equipment can operate in accordance with various qualitative and quantitative parameters, variables, setpoints, and/or thresholds or other criteria, for example. In some instances, the system 600 and/or the items of equipment can include or be coupled with one or more controllers for controlling parameters of the items of equipment, such as to receive control commands for controlling operation of the items of equipment via one or more wired, wireless, and/or user interfaces of controller.

Various components of the system 600 or portions thereof can be implemented by one or more processors coupled with or more memory devices (memory). The processors can be a general purpose or specific purpose processors, an application specific integrated circuit (ASIC), one or more field programmable gate arrays (FPGAs), a group of processing components, or other suitable processing components. The processors may be configured to execute computer code and/or instructions stored in the memories or received from other computer readable media (e.g., CDROM, network storage, a remote server, etc.). The processors can be configured in various computer architectures, such as graphics processing units (GPUs), distributed computing architectures, cloud server architectures, client-server architectures, or various combinations thereof. One or more first processors can be implemented by a first device, such as an edge device, and one or more second processors can be implemented by a second device, such as a server or other device that is communicatively coupled with the first device and may have greater processor and/or memory resources.

The memories can include one or more devices (e.g., memory units, memory devices, storage devices, etc.) for storing data and/or computer code for completing and/or facilitating the various processes described in the present disclosure. The memories can include random access memory (RAM), read-only memory (ROM), hard drive storage, temporary storage, non-volatile memory, flash memory, optical memory, or any other suitable memory for storing software objects and/or computer instructions. The memories can include database components, object code components, script components, or any other type of information structure for supporting the various activities and information structures described in the present disclosure. The memories can be communicably connected to the processors and can include computer code for executing (e.g., by the processors) one or more processes described herein.

### Machine Learning Models

The system 600 can include or be coupled with one or more first models 576. The first model 576 can include one or more neural networks, including neural networks configured as generative models. For example, the first model 576 can predict or generate new data (e.g., artificial data; synthetic data; data not explicitly represented in data used for configuring the first model 576). The first model 576 can generate any of a variety of modalities of data, such as text, speech, audio, images, and/or video data. The neural network can include a plurality of nodes, which may be arranged in layers for providing outputs of one or more nodes of one layer as inputs to one or more nodes of another layer. The neural network can include one or more input layers, one or more hidden layers, and one or more output layers. Each node can include or be associated with parameters such as weights, biases, and/or thresholds, representing how the node can perform computations to process inputs to generate outputs. The parameters of the nodes can be configured by various learning or training operations, such as unsupervised learning, weakly supervised learning, semi-supervised learning, or supervised learning.

The first model 576 can include, for example and without limitation, one or more language models, LLMs, attention-based neural networks, transformer-based neural networks, generative pretrained transformer (GPT) models, bidirectional encoder representations from transformers (BERT) models, encoder/decoder models, sequence to sequence models, autoencoder models, generative adversarial networks (GANs), convolutional neural networks (CNNs), recurrent neural networks (RNNs), diffusion models (e.g., denoising diffusion probabilistic models (DDPMs)), or various combinations thereof.

For example, the first model 576 can include at least one GPT model. The GPT model can receive an input sequence, and can parse the input sequence to determine a sequence of tokens (e.g., words or other semantic units of the input sequence, such as by using Byte Pair Encoding tokenization). The GPT model can include or be coupled with a vocabulary of tokens, which can be represented as a one-hot encoding vector, where each token of the vocabulary has a corresponding index in the encoding vector; as such, the GPT model can convert the input sequence into a modified input sequence, such as by applying an embedding matrix to the token tokens of the input sequence (e.g., using a neural network embedding function), and/or applying positional encoding (e.g., sin-cosine positional encoding) to the tokens of the input sequence. The GPT model can process the modified input sequence to determine a next token in the sequence (e.g., to append to the end of the sequence), such as by determining probability scores indicating the likelihood of one or more candidate tokens being the next token, and selecting the next token according to the probability scores (e.g., selecting the candidate token having the highest probability scores as the next token). For example, the GPT model can apply various attention and/or transformer based operations or networks to the modified input sequence to identify relationships between tokens for detecting the next token to form the output sequence.

The first model 576 can include at least one diffusion model, which can be used to generate image and/or video data. For example, the diffusional model can include a denoising neural network and/or a denoising diffusion probabilistic model neural network. The denoising neural network can be configured by applying noise to one or more training data elements (e.g., images, video frames) to generate noised data, providing the noised data as input to a candidate denoising neural network, causing the candidate denoising neural network to modify the noised data according to a denoising schedule, evaluating a convergence condition based on comparing the modified noised data with the training data instances, and modifying the candidate denoising neural network according to the convergence condition (e.g., modifying weights and/or biases of one or more layers of the neural network). In some implementations, the first model 576 includes a plurality of generative models, such as GPT and diffusion models, that can be trained separately or jointly to facilitate generating multi-modal outputs, such as technical documents (e.g., service guides) that include both text and image/video information.

In some implementations, the first model 576 can be configured using various unsupervised and/or supervised training operations. The first model 576 can be configured using training data from various domain-agnostic and/or domain-specific data sources, including but not limited to various forms of text, speech, audio, image, and/or video data, or various combinations thereof. The training data can include a plurality of training data elements (e.g., training data instances). Each training data element can be arranged in structured or unstructured formats; for example, the training data element can include an example output mapped to an example input, such as a query representing a service request or one or more portions of a service request, and a response representing data provided responsive to the query. The training data can include data that is not separated into input and output subsets (e.g., for configuring the first model 576 to perform clustering, classification, or other unsupervised ML operations). The training data can include human-labeled information, including but not limited to feedback regarding outputs of the models 576, 616.

In some implementations, the training data includes data relating to building management systems. For example, the training data can include examples of HVAC-R data, such as operating manuals, technical data sheets, configuration settings, operating setpoints, diagnostic guides, troubleshooting guides, user reports, technician reports. In some implementations, the training data used to configure the first model 576 includes at least some publicly accessible data, such as data retrievable via the Internet.

Referring further to FIG. 6, the system 600 can configure the first model 576 to determine one or more second models 616. For example, the system 600 can include a model updater 608 that configures (e.g., trains, updates, modifies, fine-tunes, etc.) the first model 576 to determine the one or more second models 616. In some implementations, the second model 616 can be used to provide application-specific outputs, such as outputs having greater precision, accuracy, or other metrics, relative to the first model, for targeted applications.

The second model 616 can be similar to the first model 576. For example, the second model 616 can have a similar or identical backbone or neural network architecture as the first model 576. In some implementations, the first model 576 and the second model 616 each include generative AI machine learning models, such as LLMs (e.g., GPT-based LLMs) and/or diffusion models. The second model 616 can be configured using processes analogous to those described for configuring the first model 576.

In some implementations, the model updater 608 can perform operations on at least one of the first model 576 or the second model 616 via one or more interfaces, such as application programming interfaces (APIs). For example, the models 576, 616 can be operated and maintained by one or more systems separate from the system 600. The model updater 608 can provide training data to the first model 576, via the API, to determine the second model 616 based on the first model 576 and the training data. The model updater 608 can control various training parameters or hyperparameters (e.g., learning rates, etc.) by providing instructions via the API to manage configuring the second model 616 using the first model 576.

### Data Sources

The model updater 608 can determine the second model 616 using data from one or more data sources 612. For example, the system 600 can determine the second model 616 by modifying the first model 576 using data from the one or more data sources 612. The data sources 612 can include or be coupled with any of a variety of integrated or disparate databases, data warehouses, digital twin data structures (e.g., digital twins of items of equipment or building management systems or portions thereof), data lakes, data repositories, documentation records, or various combinations thereof. In some implementations, the data sources 612 include HVAC-R data in any of text, speech, audio, image, or video data, or various combinations thereof, such as data associated with HVAC-R components and procedures including but not limited to installation, operation, configuration, repair, servicing, diagnostics, and/or troubleshooting of HVAC-R components and systems. Various data described below with reference to data sources 612 may be provided in the same or different data elements, and may be updated at various points. The data sources 612 can include or be coupled with items of equipment (e.g., where the items of equipment output data for the data sources 612, such as sensor data, etc.). The data sources 612 can include various online and/or social media sources, such as blog posts or data submitted to applications maintained by entities that manage the buildings. The system 600 can determine relations between data from different sources, such as by using timeseries information and identifiers of the sites or buildings at which items of equipment are present to detect relationships between various different data relating to the items of equipment (e.g., to train the models 576, 616 using both timeseries data (e.g., sensor data; outputs of algorithms or models, etc.) regarding a given item of equipment and freeform natural language reports regarding the given item of equipment).

The data sources 612 can include unstructured data or structured data (e.g., data that is labeled with or assigned to one or more predetermined fields or identifiers). For example, using the first model 576 and/or second model 616 to process the data can allow the system 600 to extract useful information from data in a variety of formats, including unstructured/freeform formats, which can allow service technicians to input information in less burdensome formats. The data can be of any of a plurality of formats (e.g., text, speech, audio, image, video, etc.), including multi-modal formats. For example, the data may be received from service technicians in forms such as text (e.g., laptop/desktop or mobile application text entry), audio, and/or video (e.g., dictating findings while capturing video).

The data sources 612 can include engineering data regarding one or more items of equipment. The engineering data can include manuals, such as installation manuals, instruction manuals, or operating procedure guides. The engineering data can include specifications or other information regarding operation of items of equipment. The engineering data can include engineering drawings, process flow diagrams, refrigeration cycle parameters (e.g., temperatures, pressures), or various other information relating to structures and functions of items of equipment.

In some implementations, the data sources 612 can include operational data regarding one or more items of equipment. The operational data can represent detected information regarding items of equipment, such as sensor data, logged data, user reports, or technician reports. The operational data can include, for example, service tickets generated responsive to requests for service, work orders, data from digital twin data structures maintained by an entity of the item of equipment, outputs or other information from equipment operation models (e.g., chiller vibration models), or various combinations thereof. Logged data, user reports, service tickets, billing records, time sheets, and various other such data can provide temporal information, such as how long service operations may take, or durations of time between service operations, which can allow the system 600 to predict resources to use for performing service as well as when to request service.

The data sources 612 can include telemetry data or point data. For example, data from equipment of a building can be streamed, sent, or transmitted to the model updater 608 or any other building platform, controller, gateway, or collector. The data can be measured temperature, humidity, pressure, or other environmental conditions for a data point. The data can be control data of a control point or set point of a piece of building equipment such as a value of a fan speed, a value of a temperature setpoint, a value of a water setpoint, etc.

The data sources 612 can include, for instance, warranty data. The warranty data can include warranty documents or agreements that indicate conditions under which various entities associated with items of equipment are to provide service, repair, or other actions corresponding to items of equipment, such as actions corresponding to service requests.

The data sources 612 can include service data. The service data can include data from any of various service providers, such as service reports. The service data can indicate service procedures performed, including associated service procedures with initial service requests and/or sensor data related conditions to trigger service and/or sensor data measured during service processes.

In some implementations, the data sources 612 can include parts data, including but not limited to parts usage and sales data. For example, the data sources 612 can indicate various parts associated with installation or repair of items of equipment. The data sources 612 can indicate tools for performing service and/or installing parts.

The system 600 can include, with the data of the data sources 612, labels to facilitate cross-reference between items of data that may relate to common items of equipment, sites, service technicians, customers, or various combinations thereof. For example, data from disparate sources may be labeled with time data, which can allow the system 600 (e.g., by configuring the models 576, 616) to increase a likelihood of associating information from the disparate sources due to the information being detected or recorded (e.g., as service reports) at the same time or near in time.

For example, the data sources 612 can include data that can be particular to specific or similar items of equipment, buildings, equipment configurations, environmental states, or various combinations thereof. In some implementations, the data includes labels or identifiers of such information, such as to indicate locations, weather conditions, timing information, uses of the items of equipment or the buildings or sites at which the items of equipment are present, etc. This can enable the models 576, 616 to detect patterns of usage (e.g., spikes; troughs; seasonal or other temporal patterns) or other information that may be useful for determining causes of issues or causes of service requests, or predict future issues, such as to allow the models 576, 616 to be trained using information indicative of causes of issues across multiple items of equipment (which may have the same or similar causes even if the data regarding the items of equipment is not identical). For example, an item of equipment may be at a site that is a museum; by relating site usage or occupancy data with data regarding the item of equipment, such as sensor data and service reports, the system 600 can configure the models 576, 616 to determine a high likelihood of issues occurring before events associated with high usage (e.g., gala, major exhibit opening), and can generate recommendations to perform diagnostics or servicing prior to the events.

In some implementations, the data sources 612 can include building information model (BIM) or industry foundation classes (IFC) data. For example, the data sources 612 can include data that provides spatial data of a building, e.g., indications of rooms, floors, buildings, etc. The data sources can include spatial context data in a variety of formats, e.g., BIM, IFC, BACnet, Haystack, LonMark, Modbus, etc. The data sources 612 can include external data. For example, the data sources 612 can include an external digital twin run by an external system or run for a different building. The external data sources can include public or private data sources, e.g., satellite images of buildings, zoning information of buildings, street maps (e.g., city, county, or state maps), weather forecast sources, etc.

### Model Configuration

Referring further to FIG. 6, the model updater 608 can perform various machine learning model configuration/training operations to determine the second models 616 using the data from the data sources 612. For example, the model updater 608 can perform various updating, optimization, retraining, reconfiguration, fine-tuning, or transfer learning operations, or various combinations thereof, to determine the second models 616. The model updater 608 can configure the second models 616, using the data sources 612, to generate outputs (e.g., completions) in response to receiving inputs (e.g., prompts), where the inputs and outputs can be analogous to data of the data sources 612.

For example, the model updater 608 can identify one or more parameters (e.g., weights and/or biases) of one or more layers of the first model 576, and maintain (e.g., freeze, maintain as the identified values while updating) the values of the one or more parameters of the one or more layers. In some implementations, the model updater 608 can modify the one or more layers, such as to add, remove, or change an output layer of the one or more layers, or to not maintain the values of the one or more parameters. The model updater 608 can select at least a subset of the identified one or parameters to maintain according to various criteria, such as user input or other instructions indicative of an extent to which the first model 576 is to be modified to determine the second model 616. In some implementations, the model updater 608 can modify the first model 576 so that an output layer of the first model 576 corresponds to output to be determined for applications 620.

Responsive to selecting the one or more parameters to maintain, the model updater 608 can apply, as input to the second model 616 (e.g., to a candidate second model 616, such as the modified first model 576, such as the first model 576 having the identified parameters maintained as the identified values), training data from the data sources 612. For example, the model updater 608 can apply the training data as input to the second model 616 to cause the second model 616 to generate one or more candidate outputs.

The model updater 608 can evaluate a convergence condition to modify the candidate second model 616 based at least on the one or more candidate outputs and the training data applied as input to the candidate second model 616. For example, the model updater 608 can evaluate an objective function of the convergence condition, such as a loss function (e.g., L1 loss, L2 loss, root mean square error, cross-entropy or log loss, etc.) based on the one or more candidate outputs and the training data; this evaluation can indicate how closely the candidate outputs generated by the candidate second model 616 correspond to the ground truth represented by the training data. The model updater 608 can use any of a variety of optimization algorithms (e.g., gradient descent, stochastic descent, Adam optimization, etc.) to modify one or more parameters (e.g., weights or biases of the layer(s) of the candidate second model 616 that are not frozen) of the candidate second model 616 according to the evaluation of the objective function. In some implementations, the model updater 608 can use various hyperparameters to evaluate the convergence condition and/or perform the configuration of the candidate second model 616 to determine the second model 616, including but not limited to hyperparameters such as learning rates, numbers of iterations or epochs of training, etc.

As described further herein with respect to applications 620, in some implementations, the model updater 608 can select the training data from the data of the data sources 612 to apply as the input based at least on a particular application of the plurality of applications 620 for which the second model 616 is to be used for. For example, the model updater 608 can select data from the parts data source 612 for the product recommendation generator application 620, or select various combinations of data from the data sources 612 (e.g., engineering data, operational data, and service data) for the service recommendation generator application 620. The model updater 608 can apply various combinations of data from various data sources 612 to facilitate configuring the second model 616 for one or more applications 620.

In some implementations, the system 600 can perform at least one of conditioning, classifier-based guidance, or classifier-free guidance to configure the second model 616 using the data from the data sources 612. For example, the system 600 can use classifiers associated with the data, such as identifiers of the item of equipment, a type of the item of equipment, a type of entity operating the item of equipment, a site at which the item of equipment is provided, or a history of issues at the site, to condition the training of the second model 616. For example, the system 600 combine (e.g., concatenate) various such classifiers with the data for inputting to the second model 616 during training, for at least a subset of the data used to configure the second model 616, which can enable the second model 616 to be responsive to analogous information for runtime/inference time operations.

### Applications

Referring further to FIG. 6, the system 600 can use outputs of the one or more second models 616 to implement one or more applications 620. For example, the second models 616, having been configured using data from the data sources 612, can be capable of precisely generating outputs that represent useful, timely, and/or real-time information for the applications 620. In some implementations, each application 620 is coupled with a corresponding second model 616 that is specifically configured to generate outputs for use by the application 620. Various applications 620 can be coupled with one another, such as to provide outputs from a first application 620 as inputs or portions of inputs to a second application 620.

The applications 620 can include any of a variety of desktop, web-based/browser-based, or mobile applications. For example, the applications 620 can be implemented by enterprise management software systems, employee or other user applications (e.g., applications that relate to BMS functionality such as temperature control, user preferences, conference room scheduling, etc.), equipment portals that provide data regarding items of equipment, or various combinations thereof. The applications 620 can include user interfaces, wizards, checklists, conversational interfaces, chatbots, configuration tools, or various combinations thereof. The applications 620 can receive an input, such as a prompt (e.g., from a user), provide the prompt to the second model 616 to cause the second model 616 to generate an output, such as a completion in response to the prompt, and present an indication of the output. The applications 620 can receive inputs and/or present outputs in any of a variety of presentation modalities, such as text, speech, audio, image, and/or video modalities. For example, the applications 620 can receive unstructured or freeform inputs from a user, such as a service technician, and generate reports in a standardized format, such as a customer-specific format. This can allow, for example, technicians to automatically, and flexibly, generate customer-ready reports after service visits without requiring strict input by the technician or manually sitting down and writing reports; to receive inputs as dictations in order to generate reports; to receive inputs in any form or a variety of forms, and use the second model 616 (which can be trained to cross-reference metadata in different portions of inputs and relate together data elements) to generate output reports (e.g., the second model 616, having been configured with data that includes time information, can use timestamps of input from dictation and timestamps of when an image is taken, and place the image in the report in a target position or label based on time correlation).

In some implementations, the applications 620 include at least one virtual assistant (e.g., virtual assistance for building management) application 620. The virtual assistant application can provide various services to support building operators, such as presenting information about the building status, modeling potential states of the building based on inputs from the user, identifying building faults and creating service requests, receiving queries regarding actions to perform to service items of equipment, and presenting responses indicating actions to perform to service items of equipment. The virtual assistant application can receive information regarding multiple buildings, a building, a portion of a building, or a piece of equipment for a building, such as sensor data, text descriptions, or camera images, and process the received information using the second model 616 to generate corresponding responses.

For example, the virtual assistant application 620 can be implemented in a UI/UX wizard configuration, such as to provide a sequence of requests for information from the user (the sequence may include requests that are at least one of predetermined or dynamically generated responsive to inputs from the user for previous requests). For example, the virtual assistant application 620 can provide one or more requests for users such as service technicians, facility managers, or other occupants, and provide the received responses to at least one of the second model 616 or a root cause detection function (e.g., algorithm, model, data structure mapping inputs to candidate causes, etc.) to determine a prediction of a cause of the issue of the item of equipment and/or solutions. The virtual assistant application 620 can use requests for information such as for unstructured text by which the user describes characteristics of the item of equipment or portion of the building relating to the issue; answers expected to correspond to different scenarios indicative of the issue; and/or image and/or video input (e.g., images of problems, equipment, spaces, etc. that can provide more context around the issue and/or configurations). For example, responsive to receiving a response via the virtual assistant application 620 indicating that the problem is with temperature in the space, the system 600 can request, via the virtual assistant application 620, information regarding HVAC-R equipment associated with the space, such as pictures of the space, an air handling unit, a chiller, or various combinations thereof.

The virtual assistant application 620 can include a plurality of applications 620 (e.g., variations of interfaces or customizations of interfaces) for a plurality of respective user types. For example, the virtual assistant application 620 can include a first application 620 for a customer user, and a second application 620 for a service technician user. The virtual assistant applications 620 can allow for updating and other communications between the first and second applications 620 as well as the second model 616. Using one or more of the first application 620 and the second application 620, the system 600 can manage continuous/real-time conversations for one or more users, and evaluate the users' engagement with the information provided (e.g., did the user, customer, service technician, etc., follow the provided steps for responding to the issue or performing service, did the user discontinue providing inputs to the virtual assistant application 620, etc.), such as to enable the system 600 to update the information generated by the second model 616 for the virtual assistant application 620 according to the engagement. In some implementations, the system 600 can use the second model 616 to detect sentiment of the user of the virtual assistant application 620, and update the second model 616 according to the detected sentiment, such as to improve the experience provided by the virtual assistant application 620.

The applications 620 can include a maintenance application. The maintenance application can execute on the data sources 612 or a digital twin. The maintenance application can output maintenance recommendations, service recommendations, schedule servicing tickets, etc. The maintenance application can determine when to replace equipment, e.g., replace a chiller, replace a thermostat, etc. The maintenance application can determine when to service a piece of equipment, e.g., recharge a refrigerant system, flush a refrigerant system, clean a duct system, etc.

The applications 620 can include an optimization application. The optimization application can receive data of the data sources 612 as an input. The optimization application can execute on data of a digital twin. The optimization application can run to determine energy consumption by the building and determine a strategy, control setting, or control schedule to reduce the energy consumption. The optimization application can execute to participate in incentive based demand response programs, capacity market programs, frequency regulation programs, or any other program.

### Feedback Training

Referring further to FIG. 6, the system 600 can include at least one feedback trainer 628 coupled with at least one feedback repository 624. The system 600 can use the feedback trainer 628 to increase the precision and/or accuracy of the outputs generated by the second models 616 according to feedback provided by users of the system 600 and/or the applications 620.

The feedback repository 624 can include feedback received from users regarding output presented by the applications 620. For example, for at least a subset of outputs presented by the applications 620, the applications 620 can present one or more user input elements for receiving feedback regarding the outputs. The user input elements can include, for example, indications of binary feedback regarding the outputs (e.g., good/bad feedback; feedback indicating the outputs do or do not meet the user's criteria, such as criteria regarding technical accuracy or precision); indications of multiple levels of feedback (e.g., scoring the outputs on a predetermined scale, such as a 1-5 scale or 1-10 scale); freeform feedback (e.g., text or audio feedback); or various combinations thereof.

The system 600 can store and/or maintain feedback in the feedback repository 624. In some implementations, the system 600 stores the feedback with one or more data elements associated with the feedback, including but not limited to the outputs for which the feedback was received, the second model(s) 616 used to generate the outputs, and/or input information used by the second models 616 to generate the outputs (e.g., service request information; information captured by the user regarding the item of equipment).

The feedback trainer 628 can update the one or more second models 616 using the feedback. The feedback trainer 628 can be similar to the model updater 608. In some implementations, the feedback trainer 628 is implemented by the model updater 608; for example, the model updater 608 can include or be coupled with the feedback trainer 628. The feedback trainer 628 can perform various configuration operations (e.g., retraining, fine-tuning, transfer learning, etc.) on the second models 616 using the feedback from the feedback repository 624. In some implementations, the feedback trainer 628 identifies one or more first parameters of the second model 616 to maintain as having predetermined values (e.g., freeze the weights and/or biases of one or more first layers of the second model 616), and performs a training process, such as a fine tuning process, to configure parameters of one or more second parameters of the second model 616 using the feedback (e.g., one or more second layers of the second model 616, such as output layers or output heads of the second model 616).

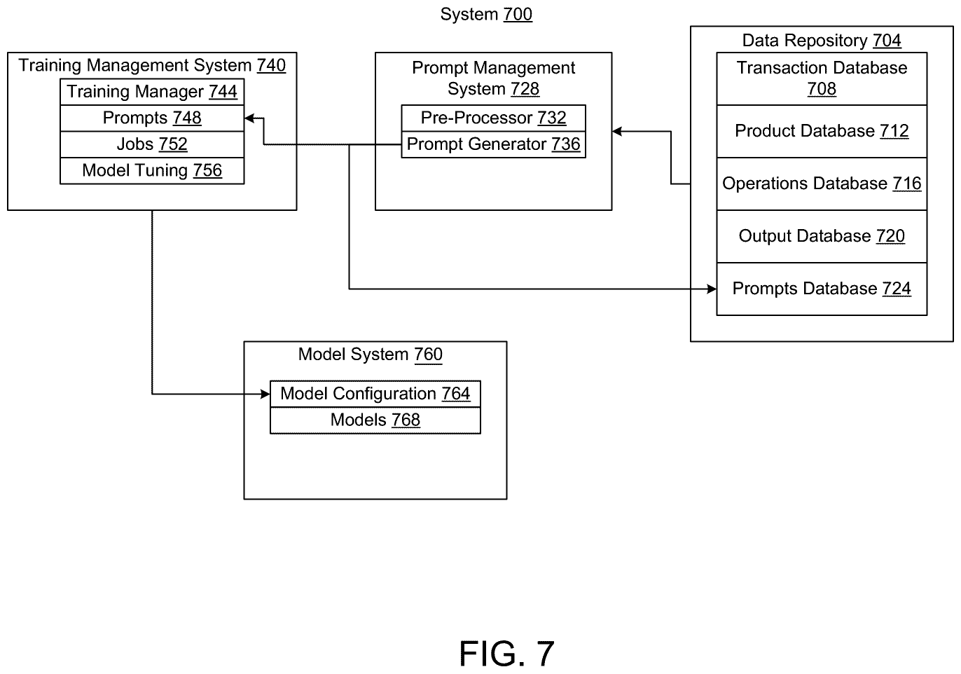

In some implementations, the system 600 may not include and/or use the model updater 608 (or the feedback trainer 628) to determine the second models 616. For example, the system 600 can include or be coupled with an output processor (e.g., an output processor similar or identical to accuracy checker 816 described with reference to FIG. 7) that can evaluate and/or modify outputs from the first model 576 prior to operation of applications 620, including to perform any of various post-processing operations on the output from the first model 576. For example, the output processor can compare outputs of the first model 576 with data from data sources 612 to validate the outputs of the first model 576 and/or modify the outputs of the first model 576 (or output an error) responsive to the outputs not satisfying a validation condition.

### Connected Machine Learning Models

Referring further to FIG. 6, the second model 616 can be coupled with one or more third models, functions, or algorithms for training/configuration and/or runtime operations. The third models can include, for example and without limitation, any of various models relating to items of equipment, such as energy usage models, sustainability models, carbon models, air quality models, or occupant comfort models. For example, the second model 616 can be used to process unstructured information regarding items of equipment into predefined template formats compatible with various third models, such that outputs of the second model 616 can be provided as inputs to the third models; this can allow more accurate training of the third models, more training data to be generated for the third models, and/or more data available for use by the third models. The second model 616 can receive inputs from one or more third models, which can provide greater data to the second model 616 for processing.

### Automated Service Scheduling and Provisioning

The system 600 can be used to automate operations for scheduling, provisioning, and deploying service technicians and resources for service technicians to perform service operations. For example, the system 600 can use at least one of the first model 576 or the second model 616 to determine, based on processing information regarding service operations for items of equipment relative to completion criteria for the service operation, particular characteristics of service operations such as experience parameters of scheduled service technicians, identifiers of parts provided for the service operations, geographical data, types of customers, types of problems, or information content provided to the service technicians to facilitate the service operation, where such characteristics correspond to the completion criteria being satisfied (e.g., where such characteristics correspond to an increase in likelihood of the completion criteria being satisfied relative to other characteristics for service technicians, parts, information content, etc.). For example, the system 600 can determine, for a given item of equipment, particular parts to include on a truck to be sent to the site of the item of equipment. As such, the system 600, responsive to processing inputs at runtime such as service requests, can automatically and more accurately identify service technicians and parts to direct to the item of equipment for the service operations. The system 600 can use timing information to perform batch scheduling for multiple service operations and/or multiple technicians for the same or multiple service operations. The system 600 can perform batch scheduling for multiple trucks for multiple items of equipment, such as to schedule a first one or more parts having a greater likelihood for satisfying the completion criteria for a first item of equipment on a first truck, and a second one or more parts having a greater likelihood for satisfying the completion criteria for a second item of equipment on a second truck.

### System Architectures for Generative AI Applications for Building Management System

FIG. 7 depicts an example of a system 700. The system 700 can include one or more components or features of the system 600, such as any one or more of the first model 576, data sources 617, second model 616, applications 620, feedback repository 624, and/or feedback trainer 628. The system 700 can perform specific operations to enable generative AI applications for building managements systems and equipment servicing, such as various manners of processing input data into training data (e.g., tokenizing input data; forming input data into prompts and/or completions), and managing training and other machine learning model configuration processes. Various components of the system 700 can be implemented using one or more computer systems, which may be provided on the same or different processors (e.g., processors communicatively coupled via wired and/or wireless connections).

The system 700 can include at least one data repository 704, which can be similar to the data sources 612 described with reference to FIG. 6. For example, the data repository 704 can include a transaction database 708, which can be similar or identical to one or more of warranty data or service data of data sources 612. For example, the transaction database 708 can include data such as parts used for service transactions; sales data indicating various service transactions or other transactions regarding items of equipment; warranty and/or claims data regarding items of equipment; and service data.

The data repository 704 can include a product database 712, which can be similar or identical to the parts data of the data sources 612. The product database 712 can include, for example, data regarding products available from various vendors, specifications or parameters regarding products, and indications of products used for various service operations. The products database 712 can include data such as events or alarms associated with products; logs of product operation; and/or time series data regarding product operation, such as longitudinal data values of operation of products and/or building equipment.

The data repository 704 can include an operations database 716, which can be similar or identical to the operations data of the data sources 612. For example, the operations database 716 can include data such as manuals regarding parts, products, and/or items of equipment; customer service data; and or reports, such as operation or service logs.

In some implementations, the data repository 704 can include an output database 720, which can include data of outputs that may be generated by various machine learning models and/or algorithms. For example, the output database 720 can include values of pre-calculated predictions and/or insights, such as parameters regarding operation items of equipment, such as setpoints, changes in setpoints, flow rates, control schemes, identifications of error conditions, or various combinations thereof.

As depicted in FIG. 7, the system 700 can include a prompt management system 728. The prompt management system 728 can include one or more rules, heuristics, logic, policies, algorithms, functions, machine learning models, neural networks, scripts, or various combinations thereof to perform operations including processing data from data repository 704 into training data for configuring various machine learning models. For example, the prompt management system 728 can retrieve and/or receive data from the data repository 704, and determine training data elements that include examples of input and outputs for generation by machine learning models, such as a training data element that includes a prompt and a completion corresponding to the prompt, based on the data from the data repository 704.

In some implementations, the prompt management system 728 includes a pre-processor 732. The pre-processor 732 can perform various operations to prepare the data from the data repository 704 for prompt generation. For example, the pre-processor 732 can perform any of various filtering, compression, tokenizing, or combining (e.g., combining data from various databases of the data repository 704) operations.

The prompt management system 728 can include a prompt generator 736. The prompt generator 736 can generate, from data of the data repository 704, one or more training data elements that include a prompt and a completion corresponding to the prompt. In some implementations, the prompt generator 736 receives user input indicative of prompt and completion portions of data. For example, the user input can indicate template portions representing prompts of structured data, such as predefined fields or forms of documents, and corresponding completions provided for the documents. The user input can assign prompts to unstructured data. In some implementations, the prompt generator 736 automatically determines prompts and completions from data of the data repository 704, such as by using any of various natural language processing algorithms to detect prompts and completions from data. In some implementations, the system 700 does not identify distinct prompts and completions from data of the data repository 704.

Referring further to FIG. 7, the system 700 can include a training management system 740. The training management system 740 can include one or more rules, heuristics, logic, policies, algorithms, functions, machine learning models, neural networks, scripts, or various combinations thereof to perform operations including controlling training of machine learning models, including performing fine tuning and/or transfer learning operations.

The training management system 740 can include a training manager 744. The training manager 744 can incorporate features of at least one of the model updater 608 or the feedback trainer 628 described with reference to FIG. 6. For example, the training manager 744 can provide training data including a plurality of training data elements (e.g., prompts and corresponding completions) to the model system 760 as described further herein to facilitate training machine learning models.

In some implementations, the training management system 740 includes a prompts database 748. For example, the training management system 740 can store one or more training data elements from the prompt management system 728, such as to facilitate asynchronous and/or batched training processes.

The training manager 744 can control the training of machine learning models using information or instructions maintained in a model tuning database 756. For example, the training manager 744 can store, in the model tuning database 756, various parameters or hyperparameters for models and/or model training.

In some implementations, the training manager 744 stores a record of training operations in a jobs database 752. For example, the training manager 744 can maintain data such as a queue of training jobs, parameters or hyperparameters to be used for training jobs, or information regarding performance of training.

Referring further to FIG. 7, the system 700 can include at least one model system 760 (e.g., one or more language model systems). The model system 760 can include one or more rules, heuristics, logic, policies, algorithms, functions, machine learning models, neural networks, scripts, or various combinations thereof to perform operations including configuring one or more machine learning models 768 based on instructions from the training management system 740. In some implementations, the training management system 740 implements the model system 760. In some implementations, the training management system 740 can access the model system 760 using one or more APIs, such as to provide training data and/or instructions for configuring machine learning models 768 via the one or more APIs. The model system 760 can operate as a service layer for configuring the machine learning models 768 responsive to instructions from the training management system 740. The machine learning models 768 can be or include the first model 576 and/or second model 616 described with reference to FIG. 6.

The model system 760 can include a model configuration processor 764. The model configuration processor 764 can incorporate features of the model updater 608 and/or the feedback trainer 628 described with reference to FIG. 6. For example, the model configuration processor 764 can apply training data (e.g., prompts 748 and corresponding completions) to the machine learning models 768 to configure (e.g., train, modify, update, fine-tune, etc.) the machine learning models 768. The training manager 744 can control training by the model configuration processor 764 based on model tuning parameters in the model tuning database 756, such as to control various hyperparameters for training. In various implementations, the system 700 can use the training management system 740 to configure the machine learning models 768 in a similar manner as described with reference to the second model 616 of FIG. 6, such as to train the machine learning models 768 using any of various data or combinations of data from the data repository 704.

### Application Session Management

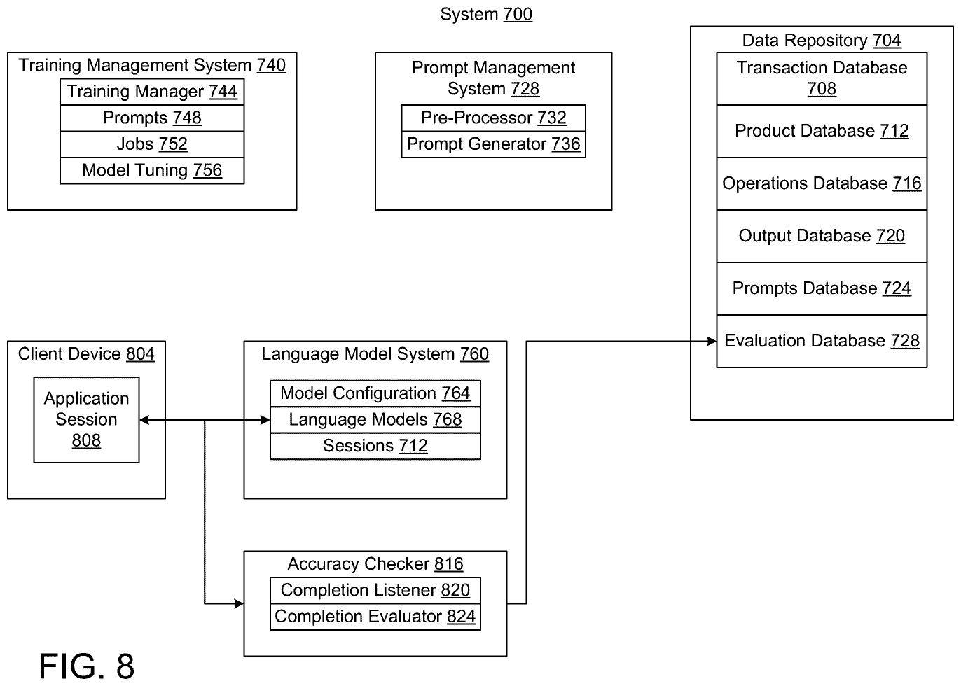

FIG. 8 depicts an example of the system 700, in which the system 700 can perform operations to implement at least one application session 808 for a client device 804. For example, responsive to configuring the machine learning models 768, the system 700 can generate data for presentation by the client device 804 (including generating data responsive to information received from the client device 804) using the at least one application session 808 and the one or more machine learning models 768.

The client device 804 can be a device of a user, such as a technician or building manager. The client device 804 can include any of various wireless or wired communication interfaces to communicate data with the model system 760, such as to provide requests to the model system 760 indicative of data for the machine learning models 768 to generate, and to receive outputs from the model system 760. The client device 804 can include various user input and output devices to facilitate receiving and presenting inputs and outputs.

In some implementations, the system 700 provides data to the client device 804 for the client device 804 to operate the at least one application session 808. The application session 808 can include a session corresponding to any of the applications 620 described with reference to FIG. 6. For example, the client device 804 can launch the application session 808 and provide an interface to request one or more prompts. Responsive to receiving the one or more prompts, the application session 808 can provide the one or more prompts as input to the machine learning model 768. The machine learning model 768 can process the input to generate a completion, and provide the completion to the application session 808 to present via the client device 804. In some implementations, the application session 808 can iteratively generate completions using the machine learning models 768. For example, the machine learning models 768 can receive a first prompt from the application session 808, determine a first completion based on the first prompt and provide the first completion to the application session 808, receive a second prompt from the application 808, determine a second completion based on the second prompt (which may include at least one of the first prompt or the first completion concatenated to the second prompt), and provide the second completion to the application session 808.

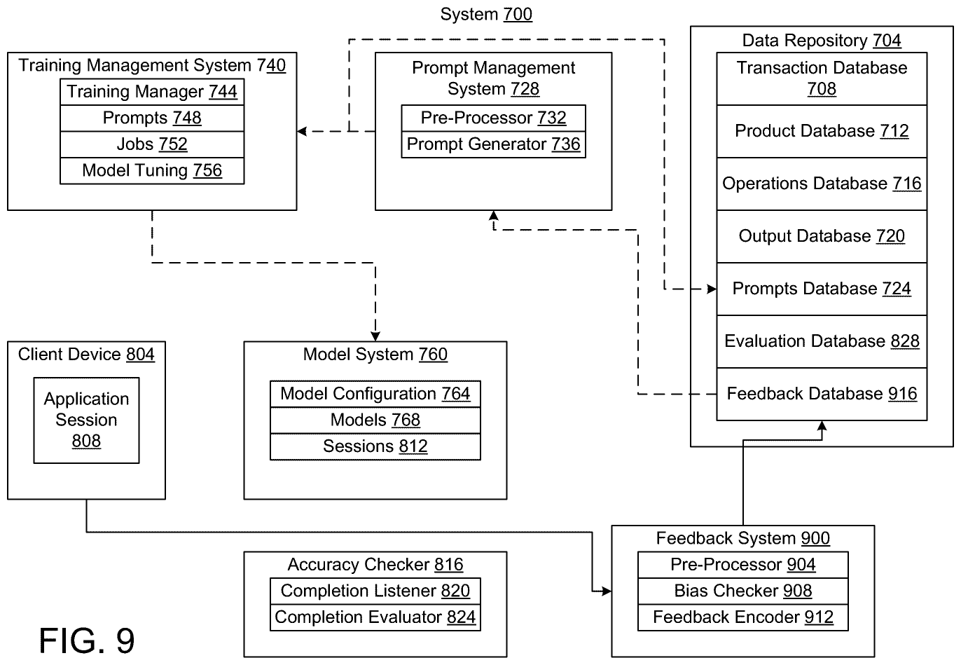

In some implementations, the model system 760 includes at least one sessions database 812. The sessions database 812 can maintain records of application session 808 implemented by client devices 804. For example, the sessions database 812 can include records of prompts provided to the machine learning models 768 and completions generated by the machine learning models 768. As described further with reference to FIG. 9, the system 700 can use the data in the sessions database 812 to fine-tune or otherwise update the machine learning models 768.

### Completion Checking

In some implementations, the system 700 includes an accuracy checker 816. The accuracy checker 816 can include one or more rules, heuristics, logic, policies, algorithms, functions, machine learning models, neural networks, scripts, or various combinations thereof to perform operations including evaluating performance criteria regarding the completions determined by the model system 760. For example, the accuracy checker 816 can include at least one completion listener 820. The completion listener 820 can receive the completions determined by the model system 760 (e.g., responsive to the completions being generated by the machine learning model 768 and/or by retrieving the completions from the sessions database 812).

The accuracy checker 816 can include at least one completion evaluator 824. The completion evaluator 824 can evaluate the completions (e.g., as received or retrieved by the completion listener 820) according to various criteria. In some implementations, the completion evaluator 824 evaluates the completions by comparing the completions with corresponding data from the data repository 704. For example, the completion evaluator 824 can identify data of the data repository 704 having similar text as the prompts and/or completions (e.g., using any of various natural language processing algorithms), and determine whether the data of the completions is within a range of expected data represented by the data of the data repository 704.

In some implementations, the accuracy checker 816 can store an output from evaluating the completion (e.g., an indication of whether the completion satisfies the criteria) in an evaluation database 828. For example, the accuracy checker 816 can assign the output (which may indicate at least one of a binary indication of whether the completion satisfied the criteria or an indication of a portion of the completion that did not satisfy the criteria) to the completion for storage in the evaluation database 828, which can facilitate further training of the machine learning models 768 using the completions and output.

### Feedback Training

FIG. 9 depicts an example of the system 700 that includes a feedback system 900, such as a feedback aggregator. The feedback system 900 can include one or more rules, heuristics, logic, policies, algorithms, functions, machine learning models, neural networks, scripts, or various combinations thereof to perform operations including preparing data for updating and/or updating the machine learning models 768 using feedback corresponding to the application sessions 808, such as feedback received as user input associated with outputs presented by the application sessions 808. The feedback system 900 can incorporate features of the feedback repository 624 and/or feedback trainer 628 described with reference to FIG. 6.

The feedback system 900 can receive feedback (e.g., from the client device 804) in various formats. For example, the feedback can include any of text, speech, audio, image, and/or video data. The feedback can be associated (e.g., in a data structure generated by the application session 808) with the outputs of the machine learning models 768 for which the feedback is provided. The feedback can be received or extracted from various forms of data, including external data sources such as manuals, service reports, or Wikipedia-type documentation.

In some implementations, the feedback system 900 includes a pre-processor 904. The pre-processor 904 can perform any of various operations to modify the feedback for further processing. For example, the pre-processor 904 can incorporate features of, or be implemented by, the pre-processor 732, such as to perform operations including filtering, compression, tokenizing, or translation operations (e.g., translation into a common language of the data of the data repository 704).

The feedback system 900 can include a bias checker 908. The bias checker 908 can evaluate the feedback using various bias criteria, and control inclusion of the feedback in a feedback database 916 (e.g., a feedback database 916 of the data repository 704 as depicted in FIG. 9) according to the evaluation. The bias criteria can include, for example and without limitation, criteria regarding qualitative and/or quantitative differences between a range or statistic measure of the feedback relative to actual, expected, or validated values.

The feedback system 900 can include a feedback encoder 912. The feedback encoder 912 can process the feedback (e.g., responsive to bias checking by the bias checker 908) for inclusion in the feedback database 916. For example, the feedback encoder 912 can encode the feedback as values corresponding to outputs scoring determined by the model system 760 while generating completions (e.g., where the feedback indicates that the completion presented via the application session 808 was acceptable, the feedback encoder 912 can encode the feedback by associating the feedback with the completion and assigning a relatively high score to the completion).

As indicated by the dashed arrows in FIG. 9, the feedback can be used by the prompt management system 728 and training management system 740 to further update one or more machine learning models 768. For example, the prompt management system 728 can retrieve at least one feedback (and corresponding prompt and completion data) from the feedback database 916, and process the at least one feedback to determine a feedback prompt and feedback completion to provide to the training management system 740 (e.g., using pre-processor 732 and/or prompt generator 736, and assigning a score corresponding to the feedback to the feedback completion). The training manager 744 can provide instructions to the model system 760 to update the machine learning models 768 using the feedback prompt and the feedback completion, such as to perform a fine-tuning process using the feedback prompt and the feedback completion. In some implementations, the training management system 740 performs a batch process of feedback-based fine tuning by using the prompt management system 728 to generate a plurality of feedback prompts and a plurality of feedback completion, and providing instructions to the model system 760 to perform the fine-tuning process using the plurality of feedback prompts and the plurality of feedback completions.

### Data Filtering and Validation Systems

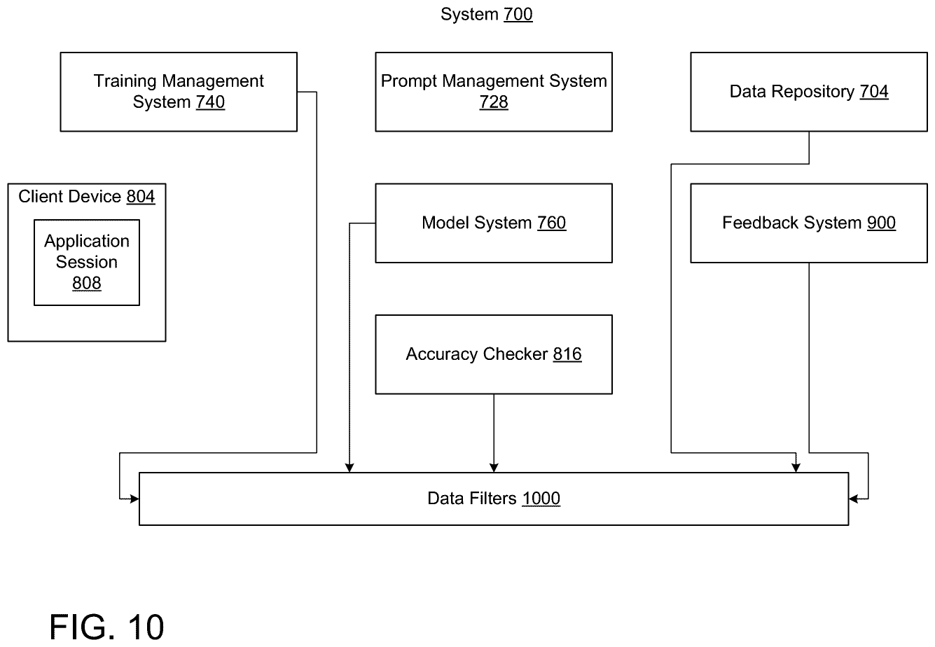

FIG. 10 depicts an example of the system 700, where the system 700 can include one or more data filters 1000 (e.g., data validators). The data filters 1000 can include any one or more rules, heuristics, logic, policies, algorithms, functions, machine learning models, neural networks, scripts, or various combinations thereof to perform operations including modifying data processed by the system 700 and/or triggering alerts responsive to the data not satisfying corresponding criteria, such as thresholds for values of data. Various data filtering processes described with reference to FIG. 10 (as well as FIGS. 6 and 7) can enable the system 700 to implement timely operations for improving the precision and/or accuracy of completions or other information generated by the system 700 (e.g., including improving the accuracy of feedback data used for fine-tuning the machine learning models 768). The data filters 1000 can allow for interactions between various algorithms, models, and computational processes.

For example, the data filters 1000 can be used to evaluate data relative to thresholds relating to data including, for example and without limitation, acceptable data ranges, setpoints, temperatures, pressures, flow rates (e.g., mass flow rates), or vibration rates for an item of equipment. The threshold can include any of various thresholds, such as one or more of minimum, maximum, absolute, relative, fixed band, and/or floating band thresholds.

The data filters 1000 can enable the system 700 to detect when data, such as prompts, completions, or other inputs and/or outputs of the system 700, collide with thresholds that represent realistic behavior or operation or other limits of items of equipment. For example, the thresholds of the data filters 1000 can correspond to values of data that are within feasible or recommended operating ranges. In some implementations, the system 700 determines or receives the thresholds using models or simulations of items of equipment, such as plant or equipment simulators, chiller models, HVAC-R models, refrigeration cycle models, etc. The system 700 can receive the thresholds as user input (e.g., from experts, technicians, or other users). The thresholds of the data filters 1000 can be based on information from various data sources. The thresholds can include, for example and without limitation, thresholds based on information such as equipment limitations, safety margins, physics, expert teaching, etc. For example, the data filters 1000 can include thresholds determined from various models, functions, or data structures (e.g., tables) representing physical properties and processes, such as physics of psychometrics, thermodynamics, and/or fluid dynamics information.

The system 700 can determine the thresholds using the feedback system 900 and/or the client device 804, such as by providing a request for feedback that includes a request for a corresponding threshold associated with the completion and/or prompt presented by the application session 808. For example, the system 700 can use the feedback to identify realistic thresholds, such as by using feedback regarding data generated by the machine learning models 768 for ranges, setpoints, and/or start-up or operating sequences regarding items of equipment (and which can thus be validated by human experts). In some implementations, the system 700 selectively requests feedback indicative of thresholds based on an identifier of a user of the application session 808, such as to selectively request feedback from users having predetermined levels of expertise and/or assign weights to feedback according to criteria such as levels of expertise.

In some implementations, one or more data filters 1000 correspond to a given setup. For example, the setup can represent a configuration of a corresponding item of equipment (e.g., configuration of a chiller, etc.). The data filters 1000 can represent various thresholds or conditions with respect to values for the configuration, such as feasible or recommendation operating ranges for the values. In some implementations, one or more data filters 1000 correspond to a given situation. For example, the situation can represent at least one of an operating mode or a condition of a corresponding item of equipment.

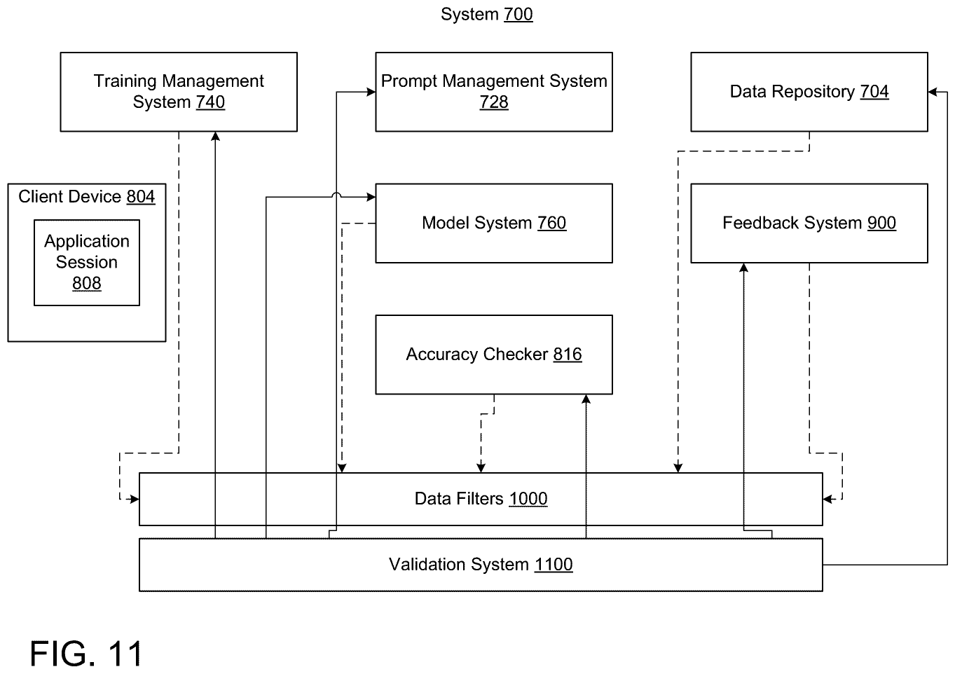

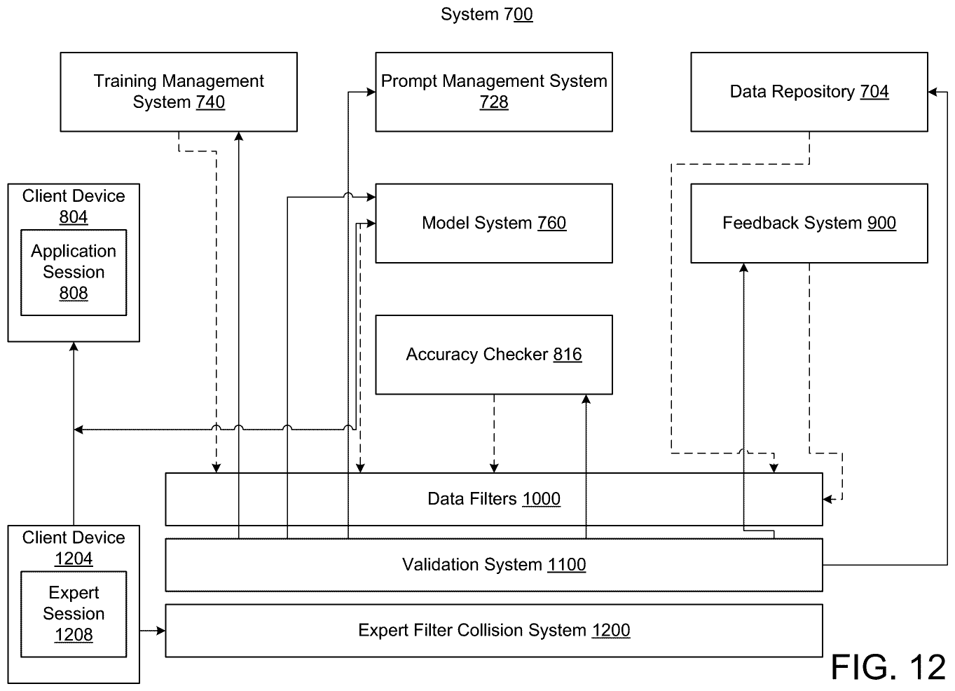

FIG. 10 depicts some examples of data (e.g., inputs, outputs, and/or data communicated between nodes of machine learning models 768) to which the data filters 1000 can be applied to evaluate data processed by the system 700 including various inputs and outputs of the system 700 and components thereof. This can include, for example and without limitation, filtering data such as data communicated between one or more of the data repository 704, prompt management system 728, training management system 740, model system 760, client device 804, accuracy checker 816, and/or feedback system 900. For example, the data filters 1000 (as well as validation system 1100 described with reference to FIG. 11 and/or expert filter collision system 1200 described with reference to FIG. 12) can receive data outputted from a source (e.g., source component) of the system 1200 for receipt by a destination (e.g., destination component) of the system 1200, and filter, modify, or otherwise process the outputted data prior to the system 1200 providing the outputted data to the destination. The sources and destinations can include any of various combinations of components and systems of the system 1200.

The system 1200 can perform various actions responsive to the processing of data by the data filters 1000. In some implementations, the system 1200 can pass data to a destination without modifying the data (e.g., retaining a value of the data prior to evaluation by the data filter 1000) responsive to the data satisfying the criteria of the respective data filter(s) 1000. In some implementations, the system 1200 can at least one of (i) modify the data or (ii) output an alert responsive to the data not satisfying the criteria of the respective data filter(s) 1000. For example, the system 1200 can modify the data by modifying one or more values of the data to be within the criteria of the data filters 1000.

In some implementations, the system 1200 modifies the data by causing the machine learning models 768 to regenerate the completion corresponding to the data (e.g., for up to a predetermined threshold number of regeneration attempts before triggering the alert). This can enable the data filters 1000 and the system 1200 selectively trigger alerts responsive to determining that the data (e.g., the collision between the data and the thresholds of the data filters 1000) may not be repairable by the machine learning model 768 aspects of the system 1200.

The system 1200 can output the alert to the client device 804. The system 1200 can assign a flag corresponding to the alert to at least one of the prompt (e.g., in prompts database 724) or the completion having the data that triggered the alert.

FIG. 11 depicts an example of the system 700, in which a validation system 1100 is coupled with one or more components of the system 700, such as to process and/or modify data communicated between the components of the system 700. For example, the validation system 1100 can provide a validation interface for human users (e.g., expert supervisors, checkers) and/or expert systems (e.g., data validation systems that can implement processes analogous to those described with reference to the data filters 1000) to receive data of the system 700 and modify, validate, or otherwise process the data. For example, the validation system 1100 can provide to human expert supervisors, human checkers, and/or expert systems various data of the system 700, receive responses to the provided data indicating requested modifications to the data or validations of the data, and modify (or validate) the provided data according to the responses.

For example, the validation system 1100 can receive data such as data retrieved from the data repository 704, prompts outputted by the prompt management system 728, completions outputted by the model system 760, indications of accuracy outputted by the accuracy checker 816, etc., and provide the received data to at least one of an expert system or a user interface. In some implementations, the validation system 1100 receives a given item of data prior to the given item of data being processed by the model system 760, such as to validate inputs to the machine learning models 768 prior to the inputs being processed by the machine learning models 768 to generate outputs, such as completions.

In some implementations, the validation system 1100 validates data by at least one of (i) assigning a label (e.g., a flag, etc.) to the data indicating that the data is validated or (ii) passing the data to a destination without modifying the data. For example, responsive to receiving at least one of a user input (e.g., from a human validator/supervisor/expert) that the data is valid or an indication from an expert system that the data is valid, the validation system 1100 can assign the label and/or provide the data to the destination.

The validation system 1100 can selectively provide data from the system 700 to the validation interface responsive to operation of the data filters 1000. This can enable the validation system 1100 to trigger validation of the data responsive to collision of the data with the criteria of the data filters 1000. For example, responsive to the data filters 1000 determining that an item of data does not satisfy a corresponding criteria, the data filters 1000 can provide the item of data to the validation system 1100. The data filters 1000 can assign various labels to the item of data, such as indications of the values of the thresholds that the data filters 1000 used to determine that the item of data did not satisfy the thresholds. Responsive to receiving the item of data from the data filters 1000, the validation system 1100 can provide the item of data to the validation interface (e.g., to a user interface of client device 804 and/or application session 808; for comparison with a model, simulation, algorithm, or other operation of an expert system) for validation. In some implementations, the validation system 1100 can receive an indication that the item of data is valid (e.g., even if the item of data did not satisfy the criteria of the data filters 1000) and can provide the indication to the data filters 1000 to cause the data filters 1000 to at least partially modify the respective thresholds according to the indication.

In some implementations, the validation system 1100 selectively retrieves data for validation where (i) the data is determined or outputted prior to use by the machine learning models 768, such as data from the data repository 704 or the prompt management system 728, or (ii) the data does not satisfy a respective data filter 1000 that processes the data. This can enable the system 700, the data filters 1000, and the validation system 1100 to update the machine learning models 768 and other machine learning aspects (e.g., generative AI aspects) of the system 700 to more accurately generate data and completions (e.g., enabling the data filters 1000 to generate alerts that are received by the human experts/expert systems that may be repairable by adjustments to one or more components of the system 700).

FIG. 12 depicts an example of the system 700, in which an expert filter collision system 1200 (“expert system” 1200) can facilitate providing feedback and providing more accurate and/or precise data and completions to a user via the application session 808. For example, the expert system 1200 can interface with various points and/or data flows of the system 1200, as depicted in FIG. 12, where the system 700 can provide data to the expert filter collision system 1200, such as to transmit the data to a user interface and/or present the data via a user interface of the expert filter collision system 1200 that can accessed via an expert session 1208 of a client device 1204. For example, via the expert session 1208, the expert session 1208 can enable functions such as receiving inputs for a human expert to provide feedback to a user of the client device 804; a human expert to guide the user through the data (e.g., completions) provided to the client device 804, such as reports, insights, and action items; a human expert to review and/or provide feedback for revising insights, guidance, and recommendations before being presented by the application session 808; a human expert to adjust and/or validate insights or recommendations before they are viewed or used for actions by the user; or various combinations thereof. In some implementations, the expert system 1200 can use feedback received via the expert session as inputs to update the machine learning models 768 (e.g., to perform fine-tuning).

In some implementations, the expert system 1200 retrieves data to be provided to the application session 808, such as completions generated by the machine learning models 768. The expert system 1200 can present the data via the expert session 1208, such as to request feedback regarding the data from the client device 1204. For example, the expert system 1200 can receive feedback regarding the data for modifying or validating the data (e.g., editing or validating completions). In some implementations, the expert system 1200 requests at least one of an identifier or a credential of a user of the client device 1204 prior to providing the data to the client device 1204 and/or requesting feedback regarding the data from the expert session 1208. For example, the expert system 1200 can request the feedback responsive to determining that the at least one of the identifier or the credential satisfies a target value for the data. This can allow the expert system 1200 to selectively identify experts to use for monitoring and validating the data.

In some implementations, the expert system 1200 facilitates a communication session regarding the data, between the application session 808 and the expert session 1208. For example, the expert session 1200, responsive to detecting presentation of the data via the application session 808, can request feedback regarding the data (e.g., user input via the application session 808 for feedback regarding the data), and provide the feedback to the client device 1204 to present via the expert session 1208. The expert session 1208 can receive expert feedback regarding at least one of the data or the feedback from the user to provide to the application session 808. In some implementations, the expert system 1200 can facilitate any of various real-time or asynchronous messaging protocols between the application session 808 and expert session 1208 regarding the data, such as any of text, speech, audio, image, and/or video communications or combinations thereof. This can allow the expert system 1200 to provide a platform for a user receiving the data (e.g., customer or field technician) to receive expert feedback from a user of the client device 1204 (e.g., expert technician). In some implementations, the expert system 1200 stores a record of one or more messages or other communications between the sessions 808, 1208 in the data repository 704 to facilitate further configuration of the machine learning models 768 based on the interactions between the users of the sessions 808, 708.

### Building Data Platforms and Digital Twin Architectures

Referring further to FIGS. 11-12, various systems and methods described herein can be executed by and/or communicate with building data platforms, including data platforms of building management systems. For example, the data repository 704 can include or be coupled with one or more building data platforms, such as to ingest data from building data platforms and/or digital twins. The client device 804 can communicate with the system 700 via the building data platform, and can feedback, reports, and other data to the building data platform. In some implementations, the data repository 704 maintains building data platform-specific databases, such as to enable the system 700 to configure the machine learning models 768 on a building data platform-specific basis (or on an entity-specific basis using data from one or more building data platforms maintained by the entity).

For example, in some implementations, various data discussed herein may be stored in, retrieved from, or processed in the context of building data platforms and/or digital twins; processed at (e.g., processed using models executed at) a cloud or other off-premises computing system/device or group of systems/devices, an edge or other on-premises system/device or group of systems/devices, or a hybrid thereof in which some processing occurs off-premises and some occurs on-premises; and/or implemented using one or more gateways for communication and data management amongst various such systems/devices. In some such implementations, the building data platforms and/or digital twins may be provided within an infrastructure such as those described in U.S. patent application Ser. No. 17/134,661 filed Dec. 28, 2020, Ser. No. 18/080,360, filed Dec. 13, 2022, Ser. No. 17/537,046 filed Nov. 29, 2021, and Ser. No. 18/096,965, filed Jan. 13, 2023, and Indian patent application No. 202341008712, filed Feb. 10, 2023, the disclosures of which are incorporated herein by reference in their entireties.

### III. AI-Based Systems and Methods for Equipment Servicing

As described above, systems and methods in accordance with the present disclosure can use machine learning and/or AI models, including, but not limited to, LLMs and other generative AI models, to ingest data regarding building management systems and equipment in various unstructured and structured formats, and generate completions and other outputs targeted to provide useful information to users. Various systems and methods described herein can use machine learning models to support applications for presenting data with high accuracy and relevance.

### Digital Twin Generation and Management Using Machine Learning Models

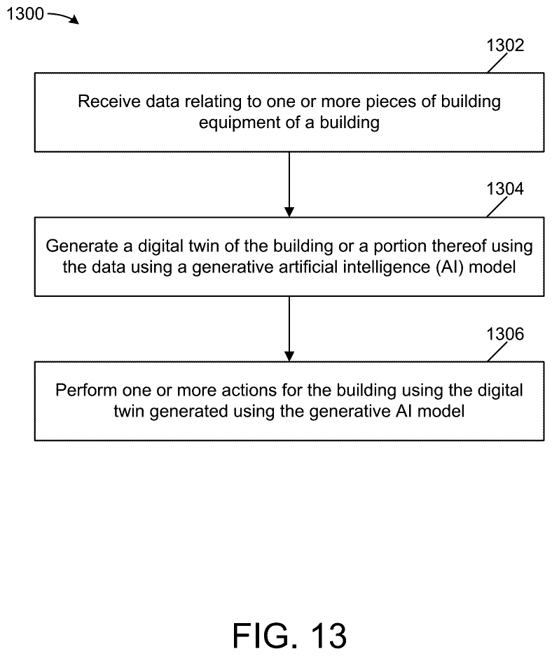

FIG. 13 depicts an example of a method 1300. The method 1300 can be performed using various devices and systems described herein, including but not limited to the systems 500, 600, 700, 1110, 1200, or one or more components thereof. Various aspects of the method 1300 can be implemented using one or more devices or systems that are communicatively coupled with one another, including in client-server, cloud-based, or other networked architectures.

At operation 1302, the twin manager 308 receives data relating to one or more pieces of building equipment of a building such as building 10. For example, the telemetry component 560 can receive telemetry data from physical devices, e.g., the building subsystems 322. The telemetry can be measured data values, a log of historical equipment commands, etc. The telemetry component 560 can store the received information in the graph 529 by relating a node storing the information to a node representing the physical device. In some embodiments, the data received at 1302 can include unstructured data that may conform to a plurality of different predetermined formats and/or the data may include unstructured not conforming to a predetermined format.

At operation 1304, the twin manager 308 can generate a digital twin of the building or a portion of the building using a generative large language model (LLM) based on the data received at operation 1302. For example, the twin manager 308 can generate a digital twin of the building 10 using model 576. In some embodiments, the twin manager 308 may generate the digital twin by generating a first new relationship for the digital twin between at least two pieces of building equipment/portions of the building. In some embodiments, the twin manager 308 may generate the digital twin by generating a first new relationship between one or more pieces of building equipment/portion of the building and one or more building entities. The building entities may include people associated with the building, location within the building, events associated with the building, or assets associated with the building. In other embodiments, the twin manager 308 may generate the digital twin by generating a first new entity for the digital twin. As explained above, a digital twin may be defined as a digital representation of an entity of a building. Therefore, when generating a digital twin, the twin manager 308 may identify a new entity for a building and generate a digital twin representing that new entity at operation 1304. For example, if a new person becomes associated with the building, the digital twin manager 308 may identify the new entity (e.g., person) and generate a digital twin representing the new person.

In some embodiments, the generative LLM is, at least in part, a pre-trained generative transformer (GPT) model. In some embodiments, the generative LLM is configured to autonomously generate the digital twin from the unstructured data which may be received at operation 1302 autonomously without requiring manual user intervention. For example, one or more components of the building subsystems 322 may be modified by removing a building component from one or more of the building subsystems 322, adding a building component from one or more of the building subsystems 322, or updating a building component from one or more the building subsystems 322. This modification may be communicated from the building subsystems 322 to the digital twin manager 308 through the network 304. The digital twin manager 308 may then generate or modify a digital twin for the building component which was added, removed, or updated using the generative LLM without requiring manual user interventions such as a user commanding the digital twin to be created.

In some embodiments, the building may be in a pre-operational phase. A pre-operational phase refers to a building which may be designed or is under construction but is not yet operational. When the building is in a pre-operational phase, in some embodiments, the digital twin manager 308 may be configured to generate a digital twin for the building, or a portion of the building, based on pre-operational design data for the building using generative LLM. The pre-operational design data for the building may include a building specification for the building and/or specifications of building materials of the building. For example, the data can include building metrics and/or floor layouts that can be used to provide an overall layout of the building. A digital twin of the building may be generated to represent the building as a whole or a portion of the building based on the specification of the building including the building metrics and/or the floor layout. Alternatively, the building may be in an operational phase and the digital twin manager 308 may be configured to generate the digital twin based on the operational data for the building. The operational data may include information about building equipment and building devices during operation. The operational data may be collected from a one or more sources including sensors associated with the building equipment/building devices, logged data, user reports, technician reports, service tickets, billing records, user timesheets, etc.

In some embodiments, the digital twin manager 308 may be configured to generate the digital twin for the building, or a portion of the building, where no digital twin currently exists for the building using generative LLM. For example, if a new wing or attachment is added to the building, the digital twin manager 308 may be configured to generate a new digital twin for the new portion building completely independently where no other digital twins currently exist. In some embodiments, the digital twin manager 308 may be configured to modify the digital twin generated by adding either a second new relationship or a second new entity for the digital twin which was not previously in the data relating to the building equipment of the building. In some embodiments, the new relationship or new entity for the digital twin may not be explicitly defined in the received data. Specifically, the generative LLM is configured to be able to determine correlations between the second new relationship and/or second new entity and the first new relationship and/or first new entity which may not be explicitly defined in the received data. Typically, explicitly defined relationships between entities can be identified by evaluating the data using deep neural networks. However, if these relationships are not explicitly defined (e.g., cannot be identified using a co-variance matrix), then a generative LLM may be used to find the “hidden” or not explicit relationships between the entities.

In some embodiments, the digital twin manager 308 may be configured to identify a new relationship or new entity of the digital twin and autonomously generate one or more tags for the new relationship and new entity in a pre-determined ontology or schema of the digital twin. The tag for the new relationship and/or new entity can include a label, characteristic, parameter, attribute, or category describing the new relationship and/or new entity. The ontology or schema can be the schema described in U.S. patent application Ser. No. 16/663,623 filed Oct. 25, 2019, the entirety of which is incorporated by reference herein. In some embodiments, the digital twin manager 308 may generate or augment the digital twin by identifying or defining both a new relationship and a new entity.

At operation 1306, the digital twin manager 308 performs one or more actions for the building using the digital twin generated at operation 1306. In some embodiments, the actions performed by twin manager 308 may include automatically generating and transmitting a control signal to control the operation of a piece of building equipment. For example, in one embodiment, a digital twin for a thermostat may be generated at operations 1302-1306. The thermostat digital twin may continually receive temperature data and may store a predetermined temperature setpoint. If the temperature data received by the thermostat digital twin passes the temperature setpoint, the temperature digital twin may generate a control signal for the thermostat to lower the temperature.

In some embodiments, actions performed by the twin manager 308 may include providing information about the building to the digital twin in response to receive a natural language query from a user. For example, a user may submit an unstructured natural language query to the building data platform 300 requesting a report on all the high priority equipment. However, what is considered “high priority equipment” may vary based on a variety of factors associated with the user. For example, if the user is the health specialist for a building, the “high priority equipment” may relate to the air quality of the building such as the airside system 200. However, if the user is an energy specialist for the building, the “high priority equipment” may be the energy related equipment. The LLM model used the generate the digital twin may be configured to take into consideration these variety of factors related to the user to provide the relevant information to the user.

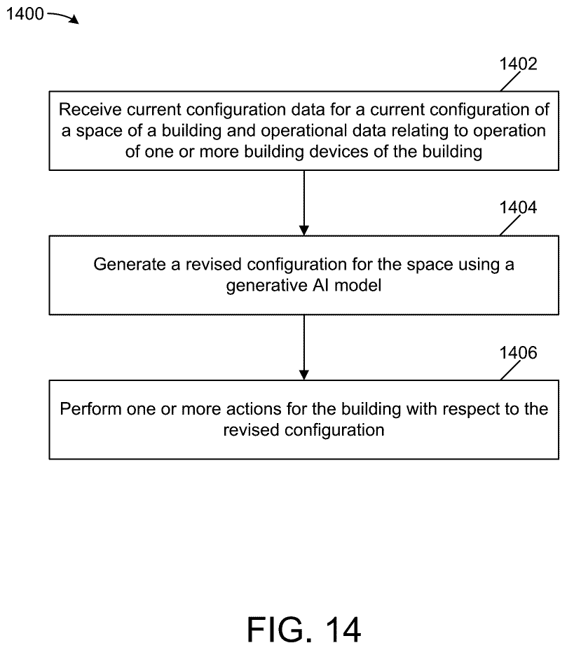

FIG. 14 depicts an example of a method 1400. The method 1400 can be performed using various devices and systems described herein, including but not limited to the systems 500, 600, 700, 1110, 1200, or one or more components thereof. Various aspects of the method 1400 can be implemented using one or more devices or systems that are communicatively coupled with one another, including in client-server, cloud-based, or other networked architectures.

At operation 1402, the building data platform 300 receives current configuration data for a current configuration of a space of a building. The building data platform 300 also receives operational data relating to the operation of one or more building devices or building equipment at operation 1402. The operational data may be collected from a one or more sources including sensors associated with the building equipment/building devices, logged data, user reports, technician reports, service tickets, billing records, user timesheets, etc. The current configuration data can also include one or more of a building information model (BIM) of the building, a building specification for the building, or a specifications of building materials of the building. For example, the current configuration data can include building metrics and/or floor layouts that can be used to provide an overall layout of the building in its current state. In some embodiments, the data received at 1402 can include unstructured data that may conform to a plurality of different predetermined formats and/or the data may include unstructured not conforming to a predetermined format.

At operation 1404, the building data platform 300 generates a revised configuration for the space using a generative AI model. In some embodiments, the generative AI model generates the revised configuration using current configuration data and the operational data of the building. In some embodiments, the generative AI model may be configured to autonomously generate the revised configuration at operation 1404 from the unstructured data received at operation 1402 without requiring manual intervention from a user. In some embodiments, the AI model described herein can include a generative large language model (LLM). For example, the AI model can provide responses that are text based responses that provide useful and relevant information. In some embodiments, the AI model can include a generative pretrained transformer (GPT) model.

In some embodiments, the building data platform 300 may generate a revised configuration to meet one or more building objectives. The building objectives may include certain environmental and sustainability metrics the building aims to meet. For example, a revised configuration may be generated which may include the sustainability performance of the building. The building objectives may include certain health metrics the building aims to meet. For example, a revised configuration may be generated by the generative AI model to improve the air quality, water quality, etc. of the building. In some embodiments, the revised configuration is a new and non-preexisting configuration which is generated autonomously by the generative AI model.

In some embodiments, the building may be in a pre-operational phase. A pre-operational phase refers to a building which may be designed or is under construction but is not yet operational. The pre-operational design data for the building may include a building specification for the building and/or specifications of building materials of the building. For example, the data can include building metrics and/or floor layouts that can be used to provide an overall layout of the building. In some embodiments, the building data platform 300 receives feedback from a user on the pre-operational design data for the building. Specifically, the feedback from the user may include a revision to the pre-operational design of the building. In some embodiments, the feedback from the user comprises unstructured natural language input not conforming to a predetermined format. In some embodiments, the generative AI model is configured to determine revisions to the pre-operational design of the building based on the natural language feedback provided by the user. In some embodiments, the generative AI model modifies the pre-operational design of the building based on the received feedback at operation 1404. In some embodiments, the generative AI model generates a new configuration of the building based on the feedback comprising the unstructured natural language input, the revised configuration, and the operational data. In some embodiments, the natural language feedback may be provided as training data to the generative AI model to re-train the generative AI model.

In some embodiments, the generative AI model is configured to simulate multiple different scenarios for the building. In some embodiments, the generative AI model may simulate different building scenarios which correspond to different weather conditions. For example, the generative AI model may simulate different building scenarios which correspond to winter weather conditions, spring weather conditions, summer weather conditions, and autumn weather conditions. In other embodiments, the generative AI model may simulate different building scenarios which correspond to different occupancy levels. For example, the generative AI model may simulate different building scenarios which correspond to a fully occupied building, a partially occupied building, or an empty building. In some embodiments, the generative AI model may be configured to generate multiple different revised configurations for a building, or the space of a building, based the different simulated scenarios. In some embodiments, the multiple different scenarios may be received as a user input which may come in an unstructured natural language format.

In some embodiments, the digital twin manager 308 may be configured to update a digital twin for the space based on the revised configuration. For example, in one example embodiment, a revised configuration of a building space may be generated based on an increased occupancy level of the space in the building due to an in-person gathering. In this case, the digital twin manager 308 may update the digital twin representing the space to reflect the increased occupancy level. In some embodiments, the building data platform 300 autonomously generates a visual representation of the building or the building space using a generative AI model. The visual representation may be based on the revised configuration of the building. In some embodiments, the visual representation of the building or building space may be a two-dimensional representation, a three-dimensional representation, or a fourth-dimensional representation.

At operation 1406, the building data platform 300 performs one or more actions for the building with respect to the revised configuration generated at operation 1404. In some embodiments, the actions performed by the building data platform 300 may include automatically generating and transmitting a control signal to control the operation of a piece of building equipment to implement the revised configuration. For example, in one embodiment, a control signal may be sent to an air handling unit to update the operation of the air handling unit to be in line with a revised configuration of the building.

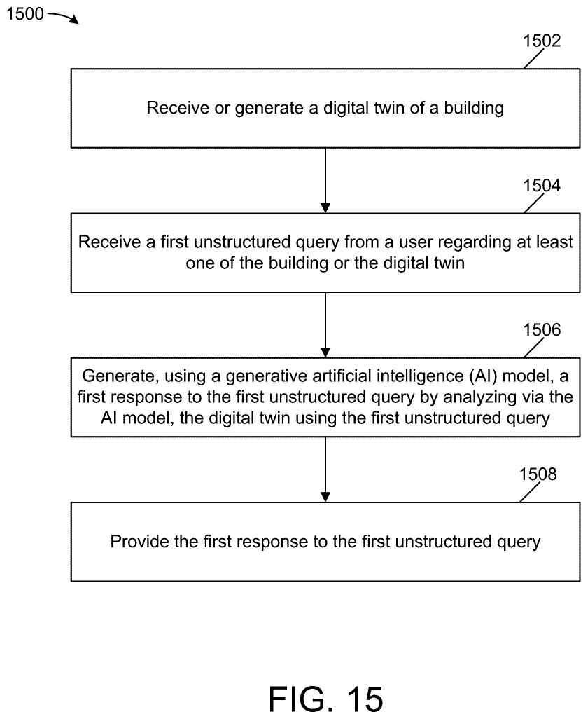

FIG. 15 depicts an example of a method 1500. The method 1500 can be performed using various devices and systems described herein, including but not limited to the systems 500, 600, 700, 1110, 1200, or one or more components thereof. Various aspects of the method 1300 can be implemented using one or more devices or systems that are communicatively coupled with one another, including in client-server, cloud-based, or other networked architectures.

At operation 1502, the digital twin manager 308 receives or generates a digital twin of the building. The digital twin manager 308 may generate the digital twin as explained above with respect to operation 1302 or receive a digital twin already generated and stored by the digital twin manager 308.

At operation 1504, the twin manager 308 receives a first unstructured query from a user about the digital twin received or generated at operation 1502. In some embodiments, the first unstructured query is a natural language query which does not conform to a predetermined format. The first unstructured query may request any information about the building. For example, the first unstructured query may request a status of a building device or piece of building equipment. As another example, the first unstructured query may request a report on faulty building devices or equipment. As another example, the first unstructured query may request a report on an occupancy level of the building. As another example, the first unstructured query may request a recommendation of how to improve the operation of the building. Specifically, the user may request a recommendation of how to improve the sustainability of the building or air quality of the building.

At operation 1506, the digital twin manager 308 generates a first response to the first unstructured query by analyzing the digital twin using a generative LLM based on the first unstructured query. In some embodiments, the digital twin manager 308 autonomously determines one or more entities and/or one or more relationships within the digital twin relevant to the first unstructured query without requiring manual user intervention. Based on the determined one or more entities and/or relationships, the digital twin manager 308 may autonomously generate the first response to the first unstructured query by analyzing data for the determined one or more entities and/or one or more relationships. In some embodiments, the data may be unstructured data that may conform to a plurality of different predetermined formats and/or the data may include unstructured not conforming to a predetermined format

In some embodiments, the generative LLM is, at least in part, a pre-trained generative transformer (GPT) model. In some embodiments, the generative LLM is configured to autonomously generate the digital twin from the unstructured data which may be analyzed at operation 1502 autonomously without requiring manual user intervention. In some embodiments, the digital twin may represent a portion of a building, an entire building, or a group of multiple builds such as a campus, a shopping center, or business park. In some embodiments, the digital twin is associated with a piece of building equipment and the first unstructured data query requests data about the piece of building equipment. The data may include information about the past and current parameters of the building.

In some embodiments, the generative LLM may generate the first response to the first unstructured query may be based on explicit information provided in the first unstructured query and implicit information inferred from the first unstructured query. For example, the implicit information may be inferred based on the context surrounding the user submitting the first unstructured query. For example, a user submitting the first unstructured query may oversee managing the airside system of the building. If this user submits a query requesting the status of the building equipment, the generative LLM may provide the status of airside building equipment without the user having to explicitly request information about the status of airside building equipment explicitly. In some embodiments, the generative LLM generates the first response to the first unstructured query using additional context around the first unstructured query. The additional context may include operation data of the building or other queries which have previously been submitted. For example, if the operational data indicates an emergency event such as a fire or flood is currently happening in the building and a user submits a query requesting the status of the building, the generative LLM may provide the status of building spaces, building equipment, or building devices which are relevant to the emergency event.

In some embodiments, the building data platform 300 may receive a reply from the user to the first response. The reply may add more details or further refine the initial query. In such an embodiment, the building data platform 300 may generate a second response to the reply based on the context of both the first unstructured query and the reply. In some embodiments, the building data platform 300 request through the first unstructured query, a prediction about the building. The prediction may include predicted future data for the building, predicting a future parameter of the building, or predicting a future state of the building. The prediction may be generated using the generative LLM in combination with another artificial intelligence model and the first response may be generated based on the prediction using the digital twin.

In some embodiments, the first response may be a natural language response. In some embodiments, the generative LLM may generate one or more follow-up prompts autonomously based on analysis of the digital twin to determine additional parameters to generate the first response to the first unstructured query. In some embodiments, the generative LLM creates a rule for the digital twin, or between the digital twin and another digital twin, via communication with the user.

At operation 1508, the first response to the first unstructured query is provided to the user. In some embodiments, the first response may be provided to the user on a user interface via the user device 376.

In some implementations, information from the service request, prescription, and application session processes can be used to perform analytics regarding entities that maintain sites and items of equipment (e.g., to evaluate customer churn). For example, information including unstructured data (e.g., service reports) regarding items of equipment and entity engagement or disengagement (e.g., deals) can be correlated to identify patterns regarding ways that service can be performed to maintain or increase the likelihood of increasing performance of one or more items of equipment of the entity, completion of deals or of maintaining engagement with the entity.

### Systems and Methods of Conversational Interfaces for Building Management Systems

Some building management systems can provide electronic fault detection services and troubleshooting services to users. For example, such systems can present interfaces that have multiple sequences of questions (e.g., yes/no questions) that require a user to navigate through the interfaces and provide responses to the questions in the sequences, based on which the systems can provide a predetermined response regarding fault detection and/or troubleshooting. The predetermined response may be rigid due to the limited amount of data used to generate the predetermined responses to user queries. Such systems can thus require complex, inflexible interfaces to be displayed and navigated. In addition, the predetermined nature of typical responses from the system can result in increased actions for navigating the interfaces, due to events in which the system provides incomplete, inaccurate, or outdated responses at the end of the interface navigation.

Systems and methods in accordance with the present disclosure provide dynamic and tailored responses to queries based on data provided from a variety of different internal and external data sources thereby improving the accuracy of the responses provided on the interfaces. Particularly, the systems and methods described herein collect and receive data from a variety of different sources including a building knowledge base, subject matter experts, and a fault detection and diagnostics circuit. Based on this data, the systems and methods can recognize building faults and anomalies and generate an output response to user query indicating a recommendation for resolving the building faults and anomalies. In some embodiments, the output response may include step-by-step instructions for resolving the building faults and anomalies.

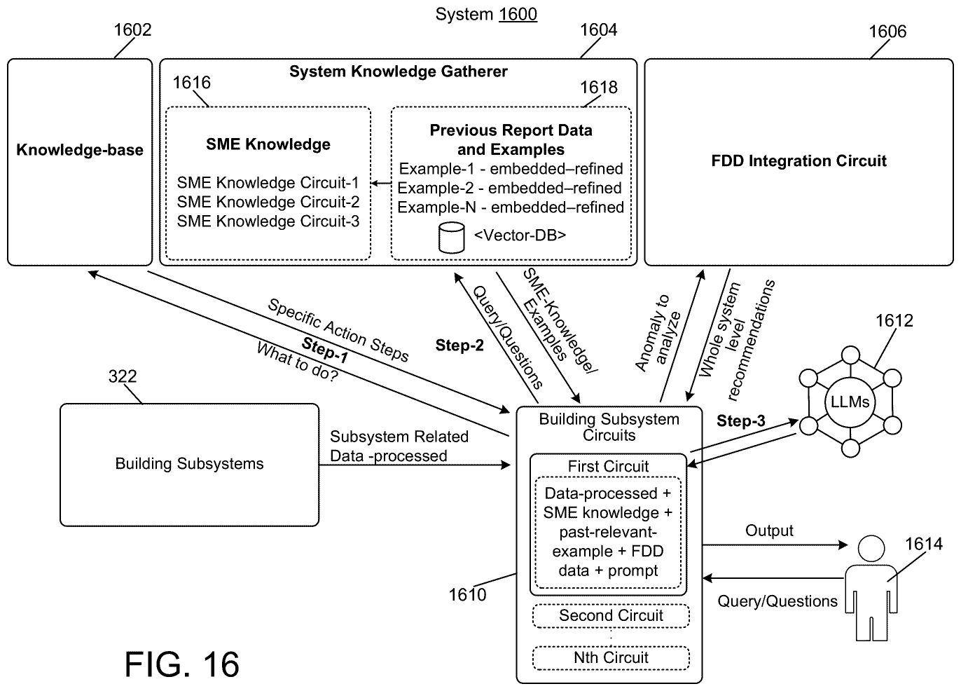

FIG. 16 depicts an example of a system 1600 for generating a response to a user query using artificial intelligence, according to some embodiments. The system 1600 can perform specific operations to enable generative AI applications for building managements systems for generating outputs in response to user queries, such as various manners of processing input data into training data (e.g., tokenizing input data; forming input data into prompts and/or completions) and managing training and other machine learning model configuration processes. Various components of the system 1600 can be implemented using one or more computer systems, which can be provided on the same or different processors (e.g., processors communicatively coupled via wired and/or wireless connections).

The example system 1600 can use machine learning models, including LLMs and other generative AI systems, to capture data, including but not limited to unstructured knowledge from various data sources, and process the data to accurately generate outputs, such as completions responsive to prompts, including in structured data formats for various applications and use cases. For example, one or more building subsystem circuits 1610 can enable real-time messaging and/or conversational interfaces (e.g., chatbots) for users to provide field data regarding equipment to the system (including presenting targeted queries to users that are expected to elicit relevant responses for efficiently receiving useful response information from users) and guide users, such as service technicians, through relevant service, diagnostic, troubleshooting, and/or repair processes.

For example, the system 1600 can provide a platform for fault detection and servicing processes in which a machine learning model is configured based on connecting or relating unstructured data and/or semantic data, such as human feedback, subject matter expert (SME) knowledge, and written/spoken reports, with time-series product data regarding items of equipment, so that the machine learning model can more accurately detect causes of alarms or other events that can trigger service responses.

In some instances, significant computational resources (or human user resources) can be required to process data relating to equipment operation, such as time-series product data and/or sensor data, to detect or predict faults and/or causes of faults. In addition, it can be resource-intensive to label such data with identifiers of faults or causes of faults, which can make it difficult to generate machine learning training data from such data. The systems and methods can leverage the efficiency of language models (e.g., GPT-based models or other pre-trained LLMs) in extracting semantic information (e.g., semantic information identifying faults, causes of faults, and other accurate expert knowledge regarding equipment servicing) from the unstructured data in order to use both the unstructured data and the data relating to equipment operation to generate more accurate outputs regarding one or more components of the building.

The example system 1600 includes one or more building subsystems 322. In some embodiments, the building subsystems 322 include, but are not limited to, a building electrical subsystem, an information communication technology (ICT) subsystem, a security subsystem, a HVAC subsystem, a lighting subsystem, a lift/escalators subsystem, and a fire safety subsystem. In various embodiments, the building subsystems 322 can include fewer, additional, or alternative subsystems. For example, the building subsystems 322 can also or alternatively include a refrigeration subsystem, an advertising or signage subsystem, a cooking subsystem, a vending subsystem, a printer or copy service subsystem, or any other type of building subsystem that uses controllable equipment and/or sensors to monitor or control building 10. In some embodiments, building subsystems 322 include waterside system 120 and/or airside system 130 as described with reference to FIG. 2. In some embodiments, pre-processed building subsystem data from the building subsystems 322 is provided to one or more building subsystem circuits 1610. The pre-processed building subsystem data can include historical time series data and/or current operating data including but not limited to, energy consumption data, operational time series data, air quality data, temperature data, water quality data, occupation data, and appliance/device data. In some embodiments, the data from the building subsystems 322 is pre-processed to transform into a standardized format which can be used for analysis by the one or more building subsystem circuits 1610.

The one or more building subsystem circuits 1610 can be configured to retrieve data from a plurality of sources and generate, using one or more LLMs 1612, an output in response to a query received by the system 1600. In some embodiments, each of the one or more building subsystem circuits 1610 are configured to process data and generate an output response directed to specific building subsystem. For example, a first building circuit can handle any queries and outputs about the airside system 200 while a second building circuit can handle any queries and outputs about the waterside system 120.

In some embodiments, the output can be generated (e.g., by one or building subsystem circuits 1610) based on the retrieved data from the plurality of data sources. In some embodiments, the plurality of data sources can include a building knowledge-base 1602, system knowledge gatherer 1604, fault detection and diagnostic (FDD) integration circuit 1606, and the building subsystems 322. In some embodiments, the one or more building subsystem circuits 1610 can receive building subsystem data for one or more building subsystems 322 as described above. In some embodiments, the one or more building subsystem circuits 1610 can retrieve subject matter expert data from the system knowledge gatherer 1604.

In some embodiments, the one or more building subsystem circuits 1610 can be configured to receive data from a user 1614. The one or more building subsystem circuits 1610 can receive, via a conversational interface, a query (e.g., a question; a request for information) from the user 1614. The query or question from the user 1614 can be directed towards the management and operation of the building subsystems 322.

The building knowledge-base 1602 cancan include a centralized database which is configured to store building data (e.g., data trends, historical data, etc.) which is gathered by an automated building management system. In some embodiments, the system 1600 can communicate with the building knowledge-base 1602 to determine additional information. For example, building knowledge-base 1602 can provide stored BAS data (e.g., data trends, historical data), as well as predetermined responses associated with predetermined user inputs. In some embodiments, the building knowledge-base 1602 can include a building manager guide which provides detailed information about each of the building subsystems. For example, the detailed information can include equipment manuals, design documents, technician service reports, or any other technical documents which provide information about the building subsystems 322. The building knowledge-base 1602 can additionally include service manuals and building automation design information relevant to servicing building equipment used within the building subsystems 322. In some embodiments, the LLMs 1612 can utilize information from the building knowledge-base 1602 to determine specific action steps that can be taken to operate and manage the building subsystems 322 or determine specific action steps that can be taken to repair any faults found in the building subsystems 322.

The system knowledge gatherer 1604 can be configured to retrieve, store, and process previous report data and examples 1618 and generate subject matter expert (SME) data 1616 based on the processed previous report data and examples 1618. The system knowledge gatherer 1604 can receive a plurality of previous report data and building subsystem use case examples for one or more of the building subsystems 322. The report data and building subsystem use case examples can be received from a variety of external and internal sources. For example, the report data and building subsystem use case examples can be received from internal equipment manuals, technician service reports, or any other documentation related to operating and servicing building equipment produced by the building manager. As another example, the report data and building subsystem use case examples can be received from external sources including external scholarly literature, external technician service reports, external user manuals, etc. In some embodiments, the report data includes cases for the one or more building subsystems in an unstructured format (e.g., natural language text, speech, etc.). In some embodiments, the unstructured report data and building subsystem use case examples can be processed to produce the SME data 1616. The SME data 1616 may be in a standardized format. In some embodiments, the SME data 1616 may be continuously refined and updated for a given building subsystem circuit as new data is received by the system knowledge gatherer.

In some embodiments, the data can also be grouped based on which subsystem they relate to. For example, all the data and example use cases related to a first building subsystem can grouped together (e.g., Example-1-embedded-refined) and all the data and example use cases related to a second building subsystem can be grouped together (e.g., Example-2-embedded-refined). In some embodiments, the processed and grouped data can be used to generate separate subject matter expert knowledge data groups which provide data about selected building subsystems (e.g., SME knowledge circuit-1, SME knowledge circuit-2, SME knowledge circuit-3, etc.). For example, there can be an airside system SME knowledge data group, a waterside system SME knowledge data group, a security system SME knowledge data group, etc. In some embodiments, the formatted example use cases and SME data are embedded into a vector and stored in a vector database.

In some embodiments, the system knowledge gatherer 1604 can be provided with one or more user questions and/or queries. The system knowledge gatherer 1604 can determine what subject matter expert data should be provided to the one or more building subsystem circuits 1610 based on the user questions and/or queries. For example, responsive to receiving a query requesting information about a given HVAC system, the system knowledge gatherer 1604 can surface subject matter expert related to the given HVAC system.

In some embodiments, the one or more building subsystem circuits 1610 can be configured to detect an anomaly in one or more of the building subsystems 322 based on the subject matter expert data 1616 and the building subsystem data. The one or more building subsystem circuits 1610 can be configured to compare the building subsystem data, which can indicate a state of the one or more building subsystems 322, such as current operation of the building subsystems 322, with the subject matter expert data 1616 which can indicate a target state with respect to how the building subsystems 322 should be operating. Responsive to detecting a difference between the subject matter expert data 1616 and the building subsystem data, the one or more building subsystem circuits 1610 can determine that an anomaly exists in the building subsystem. The one or more building subsystem circuits 1610 can provide the anomaly to the FDD integration circuit 1606.

The FDD integration circuit 1606 can include one or more fault detection and diagnostic (FDD) models or processes that can be used to detect faults or problems associated with the building equipment, predict the root causes of the faults or problems, and/or determine actions that are predicted to resolve the root causes of the faults or problems. In some embodiments, the FDD models or processes require additional information or data not included in the internal service requests or service reports. The FDD integration circuit 1606 can automatically gather the additional external information or data needed by the FDD models or processes and provide the additional information as inputs to support the FDD activities. For example, the FDD integration circuit 1606 may web crawl for external additional information which may be used by the FDD models. The FDD integration circuit 1606 can use these or other FDD models or processes to help diagnose the root causes of problems associated with the building equipment and identify the particular actions that can be taken by the system 1600 or by service providers (e.g., performing service on building equipment, repairing or replacing building equipment, switching to a new control strategy, automatically updating device software or firmware, etc.) to improve the performance of the building equipment and resolve the problems associated with the service requests and/or service reports for the building equipment.

The FDD integration circuit 1606 can be configured to analyze the anomaly determined by the one or more building subsystem circuits 1610 in the context of data provided about at least some (or all) of the building subsystems 322. Based on this analysis, the FDD integration circuit 1606 is configured to generate a recommendation, such as a whole system level recommendation, for resolving the anomaly. The whole system level recommendation can describe how to resolve the anomaly in the building subsystem the anomaly was determined to exist in while considering data from one or more other building subsystems. For example, an anomaly can be determined for an AHU subsystem. In this case, a whole system level recommendation would describe how to resolve the anomaly in the AHU subsystem while considering data from one or more of a waterside subsystem, an air quality subsystem, an energy subsystem, a HVAC subsystem, a fire safety subsystem, etc. In some embodiments, the whole system level recommendation can be a based on FDD data related to a fault determined in the building subsystems 322. The FDD data can include or be associated with FDD rules which are developed by the FDD integration circuit 1606 based on commonly identified faults, work order/repair service data, and cost analysis data. In some embodiments, at least a portion of the FDD data can be obtained from a third-party source.

The example system 1600 includes one or more generative LLMs 1612. The LLMs 1612 can produce an output to be presented to a user 1614. The LLMs 1612 can be used to receive a query or prompt inquiring about the status of one or more of the building subsystems 322. These queries, which could originate from a variety of user interfaces, can request data concerning the operation, management, or status of one or more items of equipment for the building subsystems 322. In some embodiments, the query or prompts may be received from a user device associated with the user 1614. For example, the user device may display a user interface configured to facilitate receiving a query from the user 1614 and providing the output response generated by the LLMs 1612. In some embodiments, the user interface can include a chat interface configured to facilitate conversational interaction with the user (e.g., a chat bot or generative AI interface). The user interface may prompt the user for additional information about the building subsystems 322 and provide dynamic output responses to the user based on structured or unstructured data provided by the user via the user interface.

Based on the query or prompt, the LLMs 1612 can identify anomaly and faults associated with the building subsystems 322. The LLMs 1612, powered by the processing circuits such as the building subsystem circuits 1610, interprets the user queries to generate tailored and actionable guidance. In this way, the system democratizes expert knowledge, transforming it into practical steps that can be carried out by users to manage the operation of the building subsystem. For example, the building subsystem circuits 1610 can provide the user prompt, the building subsystem data, the SME data 1616, and the FDD data including the whole system level recommendation to the LLMs 1612.

The LLMs 1612 ingest the data provided by the building subsystem circuits 1610 and uses the data provided by the building subsystem circuits 1610 (e.g., representing expert knowledge) to generate an output response to the user query. In some embodiments, the output response may be dynamic response which is based on the most recently available data provided to the LLMs 1612. The dynamic output responses generated by the LLM can include suggested resolutions to any identified building faults, potential root causes of any identified building faults, diagnostic steps to be performed to help diagnose the root cause of any identified building faults, or any other type of information that can be provided to the to help resolve the building faults. In some embodiments, the output response generated by the LLMs 1612 may include step-by-step, user-friendly guidance for technicians with varying degrees of experience. For example, the LLMs 1612 may generate action steps to implement the whole system level recommendation based on the building knowledge-base 1602.

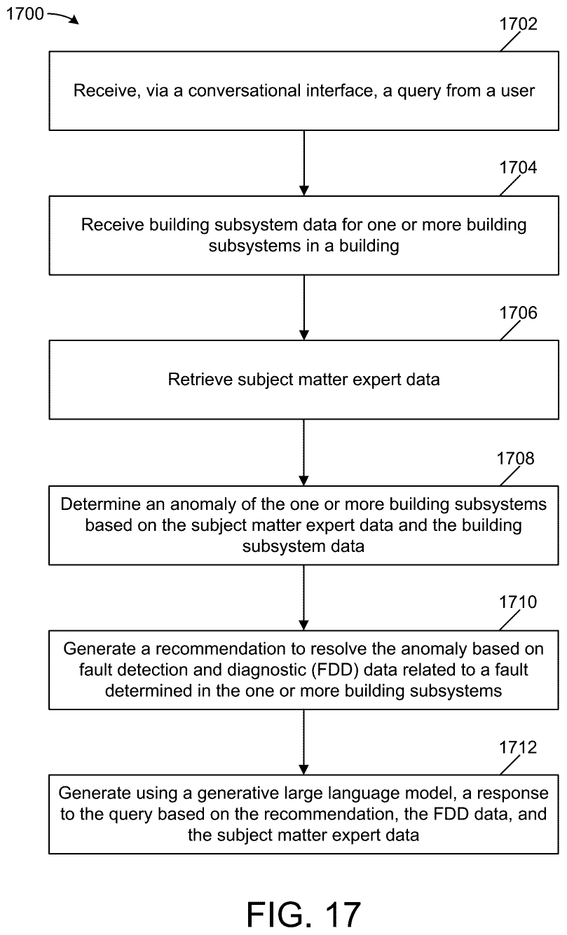

FIG. 17 depicts an example of a method 1700 for generating a response to a user query using artificial intelligence. The method 1700 can be performed using various devices and systems described herein, including but not limited to the systems 500, 600, 700, 1110, 1200, 1600, or one or more components thereof. Various aspects of the method 1700 can be implemented using one or more devices or systems that are communicatively coupled with one another, including in client-server, cloud-based, or other networked architectures.

At operation 1702, the one or more building subsystem circuits 1610, via a conversational interface, a query from a user. In some embodiments, the query may be provided as a freeform textual or audio input. In some embodiments, operation 1702 includes providing a chatbot interaction between the one or more building subsystem circuits 1610 or other system or device in the system 1600 and a user. As described above, the query or prompts may be received from a user device associated with the user 1614. For example, the user device may display a user interface configured to facilitate receiving a query from the user 1614. In some embodiments, the user interface can include a chat interface configured to facilitate conversational interaction with the user (e.g., a chat bot or generative AI interface).

At operation 1704, the one or more building subsystem circuits 1610 receives building subsystem data for the one or more building subsystems 322 in a building 10. As described above, pre-processed building subsystem data from the building subsystems 322 is provided to the one or more building subsystem circuits 1610. The pre-processed building subsystem data can include historical time series data and/or current operating data including but not limited to, energy consumption data, operational time series data, air quality data, temperature data, water quality data, occupation data, and appliance/device data. In some embodiments, the data from the building subsystems 322 is pre-processed to transform into a standardized format which can be used for analysis by the one or more building subsystem circuits 1610.

At operation 1706, the one or more building subsystem circuits 1610 retrieves subject matter expert data 1616. As described above, the subject matter expert data 1616 is generated by the system knowledge gatherer 1604 based on previous report data and building subsystem use case examples for one or more of the building subsystems 322. In some embodiments, the previous report data and building subsystem use case examples may in an unstructured format. The report data and building subsystem use case examples can be received from a variety of external and internal sources. In some embodiments, the unstructured report data and building subsystem use case examples can be processed to produce the SME data 1616. The SME data 1616 may be in a standardized format. In some embodiments, the SME data 1616 may be continuously refined and updated for a given building subsystem circuit as new data is received by the system knowledge gatherer.

At operation 1708, the one or more building subsystem circuits 1610 determines an anomaly of the one or more building subsystems 322 based on the subject matter expert data and the building subsystem data. The one or more building subsystem circuits 1610 can be configured to compare the building subsystem data, which can indicate a state of the one or more building subsystems 322, such as current operation of the building subsystems 322, with the subject matter expert data 1616 which can indicate a target state with respect to how the building subsystems 322 should be operating. Responsive to detecting a difference between the subject matter expert data 1616 and the building subsystem data, the one or more building subsystem circuits 1610 can determine that an anomaly exists in the one or more building subsystem 322.

At operation 1710, the one or more building subsystem circuits 1610 generates a recommendation to resolve the anomaly based on FDD data related to a fault determined in the one or more building subsystems. The FDD integration circuit 1606 can be configured to analyze the anomaly determined by the one or more building subsystem circuits 1610 in the context of data provided about at least some (or all) of the building subsystems 322. Based on this analysis, the FDD integration circuit 1606 is configured to generate a recommendation for resolving the anomaly.

At operation 1712, the one or more building subsystem circuits 1610 generates, using the LLMs 1612, a response to the query based on the recommendation, the FDD data, and the subject matter expert data. In some embodiments, the LLMs 1612 may include a generative large language model. The LLMs can 1612 ingest the data provided by the building subsystem circuits 1610 and uses the data provided by the building subsystem circuits 1610 (e.g., representing expert knowledge) to generate an output response to the user query. In some embodiments, the output response may be dynamic response which is based on the most recently available data provided to the LLMs 1612. In some embodiments, the output response generated by the LLMs 1612 may include step-by-step, user-friendly guidance for technicians with varying degrees of experience. For example, the LLMs 1612 may generate action steps to implement the whole system level recommendation based on the building knowledge-base 1602.

While various implementations described above are described with reference to generative AI models, it should be understood that other types of models, such as non-generative AI models like non-generative neural networks, can implement some or all of the features described above in various implementations, alone or in combination with generative AI models. For example, some or all of the features described with respect to FIGS. 13 through 15 can be implemented using non-generative AI models. All such implementations are contemplated within the scope of the present disclosure.

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied and the nature or number of discrete elements or positions can be altered or varied. Accordingly, all such modifications are intended to be included within the scope of the present disclosure. The order or sequence of any process or method steps can be varied or re-sequenced according to alternative embodiments. Other substitutions, modifications, changes, and omissions can be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure can be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps can differ from what is depicted. Also two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

In various implementations, the steps and operations described herein can be performed on one processor or in a combination of two or more processors. For example, in some implementations, the various operations could be performed in a central server or set of central servers configured to receive data from one or more devices (e.g., edge computing devices/controllers) and perform the operations. In some implementations, the operations can be performed by one or more local controllers or computing devices (e.g., edge devices), such as controllers dedicated to and/or located within a particular building or portion of a building. In some implementations, the operations can be performed by a combination of one or more central or offsite computing devices/servers and one or more local controllers/computing devices. All such implementations are contemplated within the scope of the present disclosure. Further, unless otherwise indicated, when the present disclosure refers to one or more computer-readable storage media and/or one or more controllers, such computer-readable storage media and/or one or more controllers can be implemented as one or more central servers, one or more local controllers or computing devices (e.g., edge devices), any combination thereof, or any other combination of storage media and/or controllers regardless of the location of such devices.

What is claimed is:

1. A method comprising:
receiving, by one or more processors via a conversational interface, a query from a user;
receiving, by the one or more processors, building subsystem data for one or more building subsystems in a building;
retrieving, by the one or more processors, subject matter expert data;
determining, by the one or more processors, an anomaly of the one or more building subsystems, based on the subject matter expert data and the building subsystem data;
generating, by the one or more processors, a recommendation to resolve the anomaly based on fault detection and diagnostic (FDD) data related to a fault determined in the one or more building subsystems; and
generating, by the one or more processors using a generative large language model, a response to the query based on the recommendation, the FDD data, and the subject matter expert data.

2. The method of claim 1, wherein retrieving the subject matter expert data comprises:
obtaining, by the one or more processors, previous report data, wherein the report data comprises use cases for the one or more building subsystems in an unstructured format; and
formatting, by the one or more building subsystems, the use cases into a standardized format.

3. The method of claim 2, wherein the formatted use cases are embedded into a vector and stored in a vector database.

4. The method of claim 1, wherein the FDD data comprises at least one of one or more FDD rules, work order data, or cost analysis data.

5. The method of claim 4, wherein the FDD data is generated based on data from a third-party source.

6. The method of claim 1, wherein the recommendation is a whole system level recommendation which is a recommendation for resolving a fault in a first building subsystem based on data from one or more other building subsystems in the building.

7. The method of claim 1, wherein generating, using the generative large language model, the response to the query further comprises generating action steps to implement the recommendation based on a building knowledge base.

8. A system for generating a response to a query using a generative artificial intelligence model, the system comprising:
one or more memory devices having instructions stored thereon that, when executed by one or more processors, cause the one or more processors to perform operations comprising:
receiving, via a conversational interface, a query from a user;
receiving building subsystem data for one or more building subsystems in a building;
retrieving subject matter expert data;
determining an anomaly of the one or more building subsystems, based on the subject matter expert data and the building subsystem data;
generating a recommendation to resolve the anomaly based on fault detection and diagnostic (FDD) data related to a fault determined in the one or more building subsystems; and
generating, using a generative large language model, a response to the query based on the recommendation, the FDD data, and the subject matter expert data.

9. The system of claim 8, wherein generating the subject matter expert data comprises:
obtaining previous report data, wherein the report data comprises use cases for the one or more building subsystems in an unstructured format; and
formatting the use cases into a standardized format.

10. The system of claim 9, wherein the formatted use cases are embedded into a vector and stored in a vector database.

11. The system of claim 8, wherein the FDD data comprises at least one of one or more FDD rules, work order data, or cost analysis data.

12. The system of claim 11, wherein the FDD data is generated based on data from a third-party source.

13. The system of claim 8, wherein the recommendation is a whole system level recommendation which is a recommendation for resolving a fault in a first building subsystem based on data from one or more other building subsystems in the building.

14. The system of claim 8, wherein generating, using the generative large language model, the response to the query further comprises generating action steps to implement the recommendation based on a building knowledge base.

15. One or more non-transitory computer-readable media storing program instructions that, when executed by one or more processors, cause the one or more processors to perform operations comprising:
receiving, via a conversational interface, a query from a user;
receiving building subsystem data for one or more building subsystems in a building;
retrieving subject matter expert data;
determining an anomaly of the one or more building subsystems, based on the subject matter expert data and the building subsystem data;
generating a recommendation to resolve the anomaly based on fault detection and diagnostic (FDD) data related to a fault determined in the one or more building subsystems; and
generating, using a generative large language model, a response to the query based on the recommendation, the FDD data, and the subject matter expert data.

16. The one or more non-transitory computer-readable media of claim 15, wherein generating the subject matter expert data comprises:
obtaining previous report data, wherein the report data comprises use cases for the one or more building subsystems in an unstructured format; and
formatting the use cases into a standardized format.

17. The one or more non-transitory computer-readable media of claim 16, wherein the formatted use cases are embedded into a vector and stored in a vector database.

18. The one or more non-transitory computer-readable media of claim 15, wherein the FDD data comprises at least one of one or more FDD rules, work order data, or cost analysis data.

19. The one or more non-transitory computer-readable media of claim 18, wherein the FDD data is generated based on data from a third-party source.

20. The one or more non-transitory computer-readable media of claim 15, wherein the recommendation is a whole system level recommendation which is a recommendation for resolving a fault in a first building subsystem based on data from one or more other building subsystems in the building.
